(19) United States
(12) Patent Application Publication
(10) Pub. No.: US 2024/0288883 A1
(43) Pub. Date: Aug. 29, 2024

(54) REMOTE DRIVING SYSTEM OF VEHICLE AND REMOTE DRIVING METHOD OF VEHICLE

(71) Applicant: DENSO CORPORATION, Kariya-City (JP)

(72) Inventors: Takuya KUME, Kariya-City (JP); Kazuki IZUMI, Kariya-City (JP)

(21) Appl. No.: 18/652,273

(22) Filed: May 1, 2024

Related U.S. Application Data
(63) Continuation of application No. PCT/JP2022/041142, filed on Nov. 4, 2022.

(30) Foreign Application Priority Data
Nov. 12, 2021 (JP) 2021-185009
Oct. 26, 2022 (JP) 2022-171811

(51) Int. Cl. G05D 1/80; G05D 1/227; G05D 1/698; G05D 109/10

(52) U.S. Cl. CPC G05D 1/80; G05D 1/227; G05D 1/6987; G05D 2109/10

(57) ABSTRACT

A remote driving system controls a remote driving vehicle, which is capable of performing a remote driving and an in-vehicle driving. The remote driving system is configured to: sequentially determining occurrence of an abnormality in a remote determination target, the remote determination target being a remote driver or a remote system operated by the remote driver; permit the in-vehicle driving in response to determining occurrence of the abnormality in the remote determination target; and forbid the in-vehicle driving in response to failing to determine occurrence of the abnormality in the remote determination target.

### CROSS REFERENCE TO RELATED APPLICATIONS

The present application is a continuation application of International Patent Application No. PCT/JP2022/041142 filed on Nov. 4, 2022, which designated the U.S. and claims the benefit of priority from Japanese Patent Application No. 2021-185009 filed on Nov. 12, 2021, and Japanese Patent Application No. 2022-171811 filed on Oct. 26, 2022. The entire disclosures of all of the above applications are incorporated herein by reference.

### TECHNICAL FIELD

The present disclosure relates to a remote driving system of vehicle and a remote driving method of vehicle.

### BACKGROUND

There has been known a technique of performing a remote driving of a vehicle by a driver in remote manner. In a known remote driving monitoring system, the vehicle that performs a remote driving is monitored by a remote monitoring center. In this kind of remote monitoring system, the vehicle performing autonomous driving is automatically stopped in response to a communication interruption between the vehicle and the remote monitoring center.

### SUMMARY

The present disclosure provides a remote driving system, which controls a remote driving vehicle. The remote driving vehicle is capable of performing a remote driving and an in-vehicle driving. The remote driving system is configured to: sequentially determining occurrence of an abnormality in a remote determination target, the remote determination target being a remote driver or a remote system operated by the remote driver; permit the in-vehicle driving in response to determining occurrence of the abnormality in the remote determination target; and forbid the in-vehicle driving in response to failing to determine occurrence of the abnormality in the remote determination target.

### BRIEF DESCRIPTION OF DRAWINGS

Objects, features and advantages of the present disclosure will become apparent from the following detailed description made with reference to the accompanying drawings. In the drawings:

FIG. 1 is a diagram showing a configuration of a remote driving system of vehicle according to a first embodiment of the present disclosure;

FIG. 2 is a diagram showing a configuration of a remote system;

FIG. 3 is a diagram showing a configuration of a vehicle system;

FIG. 4 is a diagram showing functions executed by an autonomous driving ECU;

FIG. 5 is a flowchart showing a process executed by a remote control device;

FIG. 6 is a flowchart showing a process executed by the vehicle system;

FIG. 7 is a flowchart showing a process executed subsequent to the flowchart shown in FIG. 6;

FIG. 8 is a diagram showing a configuration of a remote driving system of vehicle according to a second embodiment of the present disclosure;

FIG. 9 is a diagram showing a configuration of a remote system;

FIG. 10 is a diagram showing a configuration of a vehicle system;

FIG. 11 is a flowchart showing a process executed by an autonomous driving ECU in order to handle an abnormality occurred in a remote determination target;

FIG. 12 is a flowchart showing a process of switching a display on an external display unit;

FIG. 13 is a flowchart showing a process executed by a vehicle system when a remote driver is changed;

FIG. 14 is a flowchart showing a process of notifying a remote driver of occurrence of abnormality in a remote driving vehicle; and

FIG. 15 is a flowchart showing a process executed by a remote control device when an abnormality occurs in a remote driving vehicle that performs a convoy traveling.

### DETAILED DESCRIPTION

In a system which performs a remote driving of vehicle by a remote driver, when an abnormality occurs in the remote system, the remote driving of vehicle may be controlled to be stopped. In some cases, it is expected that the vehicle continues remote driving even though there is an abnormality occurred in the remote system or remote driver.

According to an aspect of the present disclosure, a remote driving system controls a remote driving vehicle. The remote driving vehicle is capable of performing a remote driving and an in-vehicle driving. The remote driving is performed by a remote driver, and the in-vehicle driving is performed by operating an in-vehicle driving operation member installed in the remote driving vehicle. The remote driving system includes: a remote abnormality determination unit sequentially determining occurrence of an abnormality in a remote determination target, the remote determination target being the remote driver or a remote system operated by the remote driver; and an in-vehicle driving permission unit permitting the in-vehicle driving in response to the remote abnormality determination unit determining occurrence of the abnormality in the remote determination target. The in-vehicle driving permission unit does not permit the in-vehicle driving when the remote abnormality determination unit fails to determine occurrence of the abnormality in the remote determination target.

According to another aspect of the present disclosure, a remote driving method controls the remote driving vehicle. The remote driving method includes: sequentially determining occurrence of an abnormality in a remote determination target, the remote determination target being the remote driver or a remote system operated by the remote driver; permitting the in-vehicle driving in response to determining occurrence of the abnormality in the remote determination target; and forbidding the in-vehicle driving in response to failing to determine occurrence of the abnormality in the remote determination target.

According to the above-described remote driving system and remote driving method, in-vehicle driving is permitted when an abnormality occurs in the remote determination target. Therefore, when an abnormality occurs in the remote determination target, the remote driving vehicle can continue traveling without stop by switching to the in-vehicle driving, in which an occupant in the vehicle performs the driving operation by operating the in-vehicle driving operation member.

The following will describe embodiments of the present disclosure with reference to accompanying drawings. In the following description, the same reference symbols are assigned to corresponding components in each embodiment in order to avoid repetitive descriptions. In each of the embodiments, when only a part of the configuration is described, the remaining parts of the configuration may adopt corresponding parts of other embodiments. Further, not only the combinations of the configurations explicitly shown in the description of the respective embodiments, but also the configurations of multiple embodiments can be partially combined even when they are not explicitly shown as long as there is no difficulty in the combination in particular.

### First Embodiment

### (Overall Configuration)

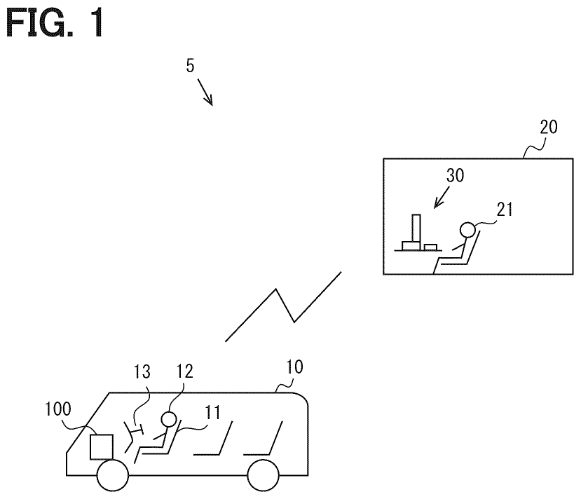

FIG. 1 shows a configuration of a remote driving system 5 of vehicle according to a first embodiment of the present disclosure. The remote driving system 5 of vehicle includes a vehicle system 100 installed in a vehicle 10 and a remote system 30 installed in a remote driving facility 20. The vehicle 10 can perform a driving in a remote manner, and is also referred to as a remote driving vehicle 10. A remote driver 21 can drive the remote driving vehicle 10 in a remote manner by operating the remote system 30. A driver 12 who is on board and sitting in a driver seat 11 can also drive the remote driving vehicle 10 by operating an in-vehicle driving operation member 13 of the remote driving vehicle 10. The driver 12 who is sitting in the driver seat is also referred to as an in-vehicle driver 12. Hereinafter, driving the remote driving vehicle 10 by operating the in-vehicle driving operation member 13 is also referred to as an in-vehicle driving.

Suppose that the remote driving vehicle 10 is capable of performing remote driving and in-vehicle driving. Various classifications of vehicles can be applied to the remote driving vehicle 10. For example, the remote driving vehicle 10 includes a passenger car, a bus, and a truck. Further, the remote driving vehicle 10 may be a vehicle that travels on a dedicated road. The remote driving vehicle 10 may be a vehicle that is not driven by an occupant in a normal state, and is driven by an on-board occupant only in an emergency. In-vehicle driving indicates operating the in-vehicle driving operation member 13 to control a movement of the remote driving vehicle 10. Herein, the driving may include only decelerating and stopping of the remote driving vehicle 10 without accelerating or steering of the remote driving vehicle 10.

The remote driving vehicle 10 is capable of performing manual driving and autonomous driving in both of the remote driving and in-vehicle driving. The remote driving vehicle 10 in the present embodiment is capable of performing autonomous driving at level 3 or lower. At autonomous driving level 3, the vehicle system 100 performs all driving operations within the operational design domain (ODD). Hereinafter, the operation design domain is referred to as ODD. Level 1 and 2 of autonomous driving are driving in which the driver is the main driver that performs the driving operation and monitoring of periphery area. In the present disclosure, a driver may refer to the remote driver 21 or the in-vehicle driver 12.

Specific examples of the in-vehicle driving operation member 13 includes a steering wheel, an accelerator pedal, and a brake pedal. In a case where the remote driving vehicle 10 is a vehicle that is operated by an occupant inside the vehicle only in an emergency, the in-vehicle driving operation member 13 does not need to include a steering wheel or a member having the same function as the steering wheel. For example, the in-vehicle driving operation member 13 may include a button for decelerating and stopping the remote driving vehicle 10.

The driving mode of remote driving vehicle 10 can be switched between the remote driving and the in-vehicle driving. The remote driving and the in-vehicle driving cannot be performed at the same time. In a remote driving state, in order to prevent the remote driving vehicle 10 from changing the current driving operation in response to an operation made on the in-vehicle driving operation member 13 by an occupant, the in-vehicle driving operation member 13 is electrically connected with an actuator operated by the in-vehicle driving operation member 13 (hereinafter referred to as a corresponding actuator). During the remote driving state, the in-vehicle driving operation member 13 and the corresponding actuator are electrically disconnected from one another.

### (Configuration of Remote System)

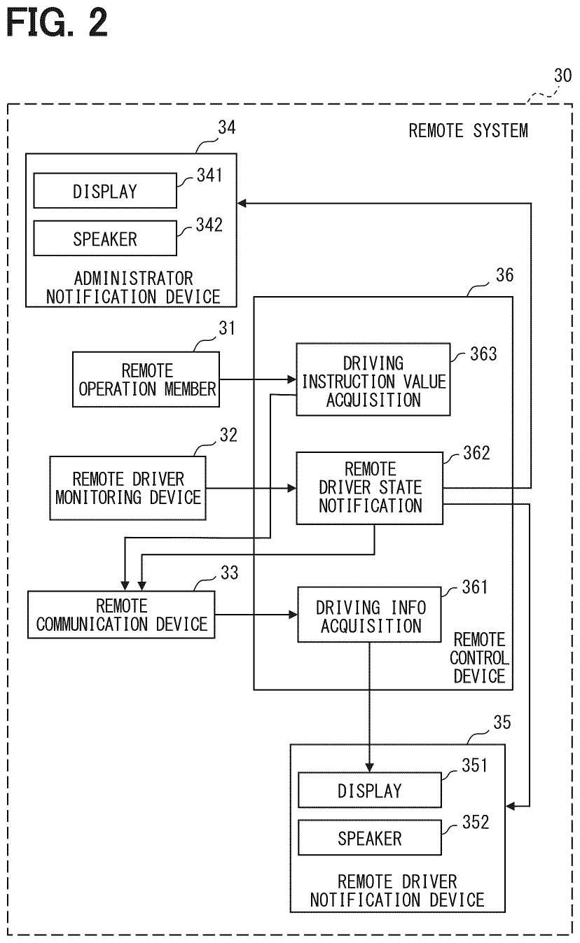

FIG. 2 shows a configuration of the remote system 30. The remote system 30 includes a remote operation member 31, a remote driver monitoring device 32, a remote communication device 33, an administrator notification device 34, a remote driver notification device 35, and a remote control device 36.

The remote operation member 31 is operated by the remote driver 21 in the remote driving state. Similar to the in-vehicle driving operation member 13, the remote operation member 31 may include a steering wheel, an accelerator pedal, or a brake pedal. Instead of the steering wheel, a rod-shaped operation member may be used as the steering wheel. Instead of the accelerator pedal or brake pedal, a button may be used.

The remote driver monitoring device 32 sequentially monitors whether the remote driver 21 is in a state suitable for the remote driving. Whether the state is suitable for the remote driving is determined from a consciousness level and a driving posture of the remote driver 21. The remote driver monitoring device 32 may include a near-infrared light source, a near-infrared camera, and a control unit that controls these components. The remote driver monitoring device 32 uses the near-infrared camera to capture an image of a head of the remote driver 21 by irradiating the head with near-infrared light emitted from the near-infrared light source. The image captured by the near-infrared camera is analyzed by the control unit. The control unit sequentially determines the driver's consciousness level based on the analysis result of captured image.

When the remote driving vehicle 10 is being remotely operated automatically at the autonomous driving level 3, the remote driver monitoring device 32 sequentially monitors whether the remote driver 21 can take over the driving operation in response to a system request. When the consciousness level of the remote driver 21 is sufficiently high and the posture of the remote driver 21 enables the remote driver to immediately perform the driving operation by operating the remote operation member 31, it is determined that the remote driver 21 can take over the driving operation.

The remote communication device 33 wirelessly communicates with an on-board communication device 180 included in the vehicle system 100. The remote communication device 33 may communicate with the on-board communication device 180 via a public communication network, or may directly communicate with the on-board communication device 180 using a predetermined communication method.

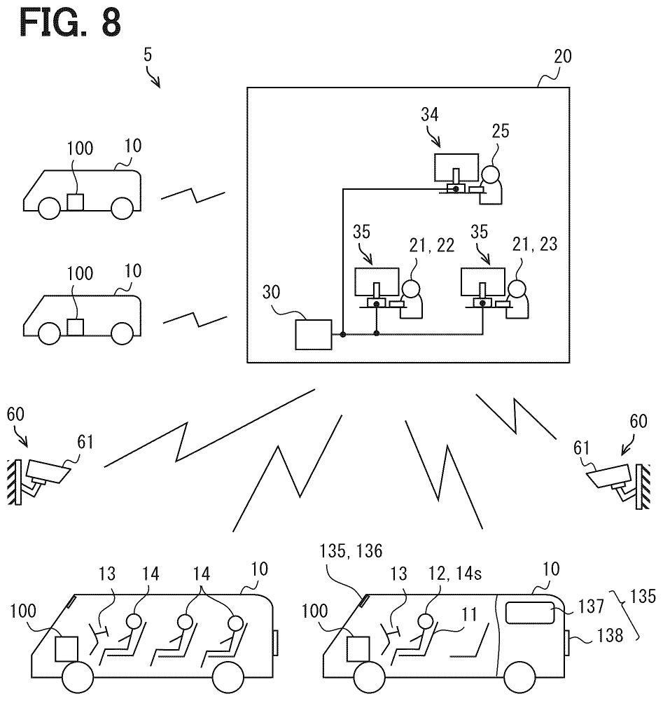

The administrator notification device 34 manages the remote driver 21 and provides various notifications to an administrator (see FIG. 8, remote administrator 25). The administrator is a person who is different from the remote driver 21. The administrator can operate the remote system 30. The administrator notification device 34 includes a display 341 and a speaker 342. The display 341 and the speaker 342 are installed at a position to be easily recognized by the administrator.

The remote driver notification device 35 provides various notifications to the remote driver 21. The remote driver notification device 35 includes a display 351 and a speaker 352. The display 351 and the speaker 352 are installed close to a seat of the remote driver 21. When an administrator 25 is near the remote driver 21, the remote driver notification device 35 may also serve as an administrator notification device 34.

The remote control device 36 may be implemented with at least one processor. For example, the remote control device 36 can be implemented by a computer including a processor, a non-volatile memory, a random access memory (RAM), input/output interface (I/O), and a bus line connecting these components. A program for controlling a general-purpose computer to operate as the remote control device 36 may be stored in the non-volatile memory. When the processor executes the program stored in the non-volatile memory by using temporary memory function of the RAM, the remote control device 36 operates as a driving information acquisition unit 361, a remote driver state notification unit 362, and a driving instruction value acquisition unit 363. Execution of the program corresponds to execution of a method corresponding to the program.

The driving information acquisition unit 361 acquires driving information from the remote communication device 33 and displays the acquired driving information on the display 351. The driving information is information necessary for remotely driving the remote driving vehicle 10. The driving information is transmitted from the remote driving vehicle 10. The driving information includes information indicating an image of periphery of the remote driving vehicle 10, a vehicle speed of the remote driving vehicle 10, and a steering angle of the remote driving vehicle 10.

The remote driver state notification unit 362 acquires, from the remote driver monitoring device 32, the monitoring result that is sequentially determined by the remote driver monitoring device 32. Then, the acquired monitoring result is transmitted from the remote communication device 33 to the remote driving vehicle 10. The monitoring result include whether the remote driver 21 is in a state suitable for the remote driving and the consciousness level of the remote driver 21. When the acquired monitoring result indicates that the remote driver 21 is not in a state suitable for the remote driving, the remote driver state notification unit 362 outputs a warning from the remote driver notification device 35. When a determination result of the remote driver monitoring device 32 does not change even though the remote driver notification device 35 outputs a warning, the remote driver state notification unit 362 outputs, to the administrator notification device 34, a notification indicating that the remote driver 21 is in abnormal state.

The driving instruction value acquisition unit 363 acquires a driving instruction value from the remote operation member 31, and transmits the acquired driving instruction value from the remote communication device 33 to the remote driving vehicle 10. The driving instruction value is a value that instructs how to drive the remote driving vehicle 10. The driving instruction value may include a value that instructs an accelerator operation amount, a brake operation amount, or a steering operation amount.

### (Configuration of Vehicle System)

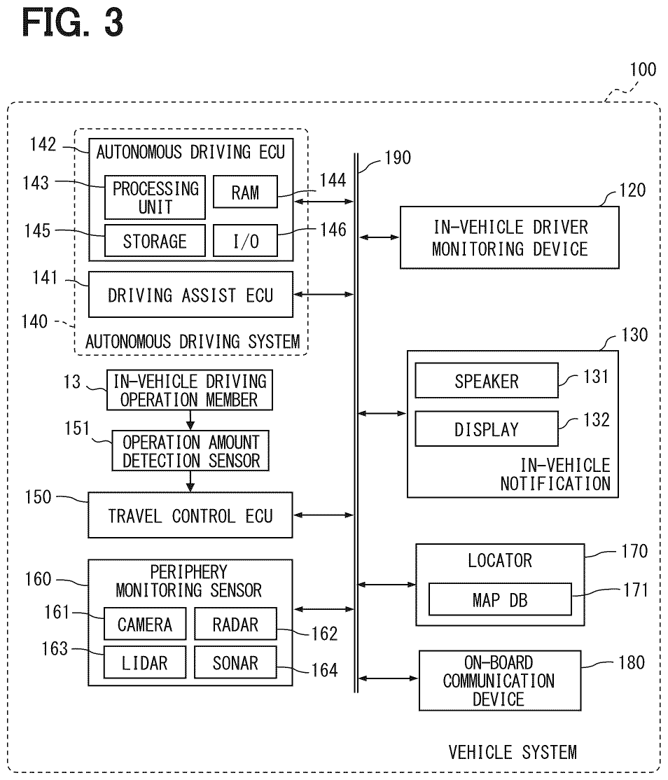

The following will describe a configuration of the vehicle system 100 with reference to FIG. 3. The vehicle system 100 includes an in-vehicle driver monitoring device 120, an in-vehicle notification unit 130, an autonomous driving system 140, a travel control ECU 150, a periphery monitoring sensor 160, a locator 170, an on-board communication device 180, and a communication bus 190 that connects these components in communicable manner.

The in-vehicle driver monitoring device 120 sequentially monitors whether the in-vehicle driver 12 is in a state suitable for performing driving operation when the in-vehicle driver 12 is in driving state. The configuration of in-vehicle driver monitoring device 120 may be similar to that of the remote driver monitoring device 32. Whether the in-vehicle driver 12 is in a state suitable for performing driving operation can be determined from the posture and consciousness level of the in-vehicle driver 12. When the remote driving vehicle 10 is autonomously driving at the autonomous driving level 3 by remote driving, the in-vehicle driver monitoring device 120 sequentially monitors whether the in-vehicle driver 12 is able to take over the driving operation.

The in-vehicle notification unit 130 provides various notifications to the driver. The in-vehicle notification unit 130 includes a speaker 131 and a display 132. The speaker 131 outputs sound toward the compartment of the remote driving vehicle 10. As the display 132, one or more display units may be provided. At least one display 132 is arranged at a position visible to the driver. For example, the at least one display 132 may be located on the instrument panel of the remote driving vehicle 10.

The autonomous driving system 140 performs autonomous driving control on the remote driving vehicle 10 when the remote driving vehicle 10 autonomously drives at least at the autonomous driving level 3. The autonomous driving system 140 may control the remote driving vehicle 10 to perform autonomous driving at the autonomous driving level 4 or higher.

At the autonomous driving level 3, the driver is not obligated to monitor a periphery of the vehicle. At the autonomous driving level 3, the driver is required to be prepared for taking over the driving operation in response to a system request of takeover. In this embodiment, the driver is either the remote driver 21 or the in-vehicle driver 12.

At the autonomous driving level 3, the ODD is required to be satisfied. When the autonomous driving system 140 determines that the ODD is no longer satisfied during the autonomous driving at autonomous driving level 3, the system requests the driver to take over the driving operation. ODD can be set in various manners. One or more of road condition, geographical condition, environmental condition, and other conditions may be set in the ODD. An example of ODD, the road type is limited to highway.

At the autonomous driving level 2, the driver takes the initiative in driving of the remote driving vehicle 10, and the autonomous driving system 140 provides driving assist for the driver. At the autonomous driving level 2, the driver has obligation to monitor the periphery of vehicle.

The autonomous driving system 140 includes a driving assist ECU 141 and an autonomous driving ECU 142. The driving assist ECU 141 is an electronic control unit (ECU) that successively determines vehicle control when the autonomous driving system 140 executes autonomous driving that performs driving assist. The autonomous driving ECU 142 is an ECU that successively determines vehicle control when the autonomous driving system 140 executes the autonomous driving at a level that does not require monitoring obligation for the driver.

The autonomous driving ECU 142 is implemented by a computer including a processing unit 143, a RAM 144, a storage 145, an input output interface 146, a bus connecting these components. The driving assist ECU 141 is also implemented by a computer including a processing unit, a RAM, a storage, an input output interface, a bus connecting these components.

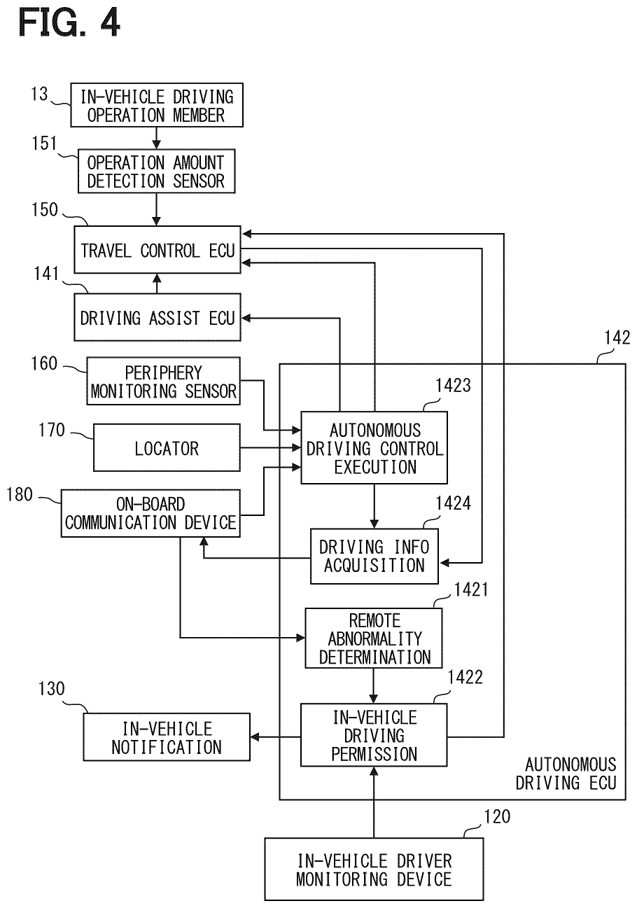

The processing unit 143 includes at least one processor. The processing unit 143 accesses the RAM 144 to execute various processes performing the remote driving method of vehicle according to the present disclosure. The storage 145 stores various programs (vehicle remote driving program) to be executed by the processing unit 143. By executing the program with the processing unit 143, the autonomous driving ECU 142 performs the function of each functional unit shown in FIG. 4. The following will describe details of FIG. 4.

The travel control ECU 150 corresponds to a travel control unit, and is implemented by an electronic control device that mainly includes a microcontroller. The travel control ECU 150 has at least functions of a brake control ECU, a drive control ECU, and a steering control ECU. The travel control ECU 150 successively controls a brake force of each wheel, controls an output of vehicle-mounted power source, and controls a steering wheel angle, based on one of (i) the driving instruction value corresponding to the driving operation made by the in-vehicle driver 12 or the remote driver 21, (ii) a control instruction value from the driving assist ECU 141, or (iii) a control instruction value from the autonomous driving ECU 142.

The driving instruction value corresponding to the driving operation of made by the in-vehicle driver 12 is a detection value detected by an operation amount detection sensor 151. The operation amount detection sensor 151 detects an operation amount of the in-vehicle driving operation member 13. The value detected by the operation amount detection sensor 151 indicates the operation amount of the in-vehicle driving operation member 13 when operated by the in-vehicle driver.

The driving instruction value corresponding to the driving operation made by the remote driver 21 is transmitted from the remote system 30 to the remote driving vehicle and is received by the on-board communication device 180. In the remote driving state, the travel control ECU 150 performs travel control based on the driving instruction value corresponding to the driving operation made by the remote driver 21. In the remote driving state, the travel control ECU 150 sequentially acquires the detection value detected by the operation amount detection sensor 151, in other words, even when an in-vehicle driving permission unit 1422 does not permit the in-vehicle driving. This is to promptly execute travel control that reflects the driving operation made by the in-vehicle driver 12 when switching to the in-vehicle driving.

The travel control ECU 150 generates vehicle speed information indicating a current travel speed of the remote driving vehicle 10 based on a detection signal of a wheel speed sensor arranged at a hub portion of each wheel, and sequentially outputs the generated vehicle speed information to the communication bus 190.

The periphery monitoring sensor 160 is an autonomous sensor that monitors a periphery environment of the emote driving vehicle 10. The periphery monitoring sensor 160 can detect moving objects and stationary objects within a detection range defined around the vehicle. The periphery monitoring sensor 160 is capable of detecting at least a front vehicle, a rear vehicle, a side vehicle, which travels in a periphery area of the remote driving vehicle 10. The periphery monitoring sensor 160 provides detection information about objects detected around the own vehicle, that is, the remote driving vehicle 10, to the driving assist ECU 141 and the autonomous driving ECU 142.

The periphery monitoring sensor 160 may include at least one of a camera unit 161, a millimeter wave radar 162, a lidar 163, or a sonar 164. The camera unit 161 includes a front camera system and a surround camera system. The front camera system is mounted on the remote driving vehicle 10 and captures a front area of the remote driving vehicle 10. The surround camera system includes a front camera, a rear camera, a left lateral camera, and a right lateral camera. The surround camera system captures an image of a road surface around the remote driving vehicle 10. The millimeter wave radar 162 radiates millimeter waves or quasi-millimeter waves toward a periphery area of own vehicle. The millimeter wave radar 162 outputs detection information generated by processing waves reflected by a moving object, a stationary object, or the like. The lidar 163 emits laser light toward the periphery area of own vehicle. The lidar 163 outputs detection information generated by processing received laser light reflected by a moving object, a stationary object, or the like existing in an irradiation range. The sonar 164 emits ultrasonic wave toward the periphery area of own vehicle. The sonar 164 outputs detection information generated by processing received ultrasonic wave reflected by a moving object, a stationary object, or the like existing near the own vehicle.

The locator 170 includes a global navigation satellite system (GNSS) receiver, an inertial sensor, and the like. The locator 170 combines positioning signals received by the GNSS receiver, measurement results of the inertial sensor, the vehicle speed information outputted to the communication bus 190, and successively determines the current position and traveling direction of the remote driving vehicle 10. The locator 170 successively outputs, to the communication bus 190, the location information and the direction information of the remote driving vehicle 10, which is acquired based on the positioning result, as locator information.

The locator 170 further includes a map database (hereinafter, referred to as map DB) 171 that stores map data. The map DB 171 mainly includes a large capacity storage medium for storing a large number of three-dimensional map data records and two-dimensional map data records. The three-dimensional map data is also known as high definition (HD) map, and includes road information necessary for the autonomous driving control. The three-dimensional map data includes information necessary for advanced driving support and autonomous driving, such as three-dimensional shape information of roads and detailed information on each lane. The locator 170 reads out map data around the current position of own vehicle from the map DB 171, and provides the read-out map data to the driving assist ECU 141, autonomous driving ECU 142, together with the locator information.

The on-board communication device 180 is an external communication device mounted on the remote driving vehicle 10, and functions as a vehicle to everything (V2X) communication device. The on-board communication device 180 communicates with the remote communication device 33 via a public communication network or in direct manner. The on-board communication device 180 may transmit and receive information by wireless communication to and from a roadside device installed at a roadside.

### (Functions Executed by Autonomous Driving ECU)

FIG. 2 shows functions executed by the autonomous driving ECU 142. The autonomous driving ECU 142 functions as a remote abnormality determination unit 1421, an in-vehicle driving permission unit 1422, an autonomous driving control execution unit 1423, and a driving information acquisition unit 1424, by executing the program with the processing unit 143.

The remote abnormality determination unit 1421 sequentially determines whether an abnormality occurs in a remote determination target in the remote driving state. The remote determination target is at least one of the remote driver 21 or the remote system 30. The remote determination target may be both of the remote driver 21 and the remote system 30. The remote driver 21 having an abnormality indicates that the remote driver 21 is not in a state suitable for remote driving. An abnormality occurrence in the remote driver 21 is determined based on whether the remote system 30 notifies that the remote driver 21 is not in a suitable state for the remote driving. That is, when the remote system notifies that the remote driver 21 is not in a suitable state for the remote driving, it is determined that an abnormality is occurred in the remote driver.

In response to determining that there is no abnormality occurred in the remote driver 21, the remote abnormality determination unit 1421 further determines whether there is a sign of abnormality in the remote driver 21. The sign of abnormality is determined based on the consciousness level of the remote driver 21. When the consciousness level of the remote driver is not abnormal but is close to abnormal state, it can be determined that the remote driver has the sign of abnormality. For example, when the ratio of period during which the consciousness level of the remote driver 21 is an abnormal range to a certain period of time is equal to or higher than a first ratio, it can be determined that the remote driver 21 is in the abnormal state. When the ratio of period during which the consciousness level of the remote driver 21 is the abnormal range to the certain period of time is lower than the first ratio and higher than a second ratio, the remote driver 21 is determined to have the sign of abnormality. The second ratio is set to be lower than the first ratio. When the remote driver 21 seems to be a little sleepy, it can be determined that the remote driver 21 has the sign of abnormality.

The remote abnormality determination unit 1421 determines whether there is an abnormality in the remote system 30 based on whether information is periodically transmitted from the remote system 30. When the information is not periodically transmitted from the remote system 30 even though remote driving is in progress, it is determined that there is an abnormality in the remote system 30. When a signal notifying a system abnormality is obtained from the remote system 30, the autonomous driving control execution unit 1423 may determine that an abnormality is occurred in the remote system 30. An example of abnormality occurred in the remote system 30 may be an abnormality occurred in the remote communication device 33.

The in-vehicle driving permission unit 1422 successively determines whether to permit the in-vehicle driver 12 to drive the remote driving vehicle 10. In the remote driving state, when the remote abnormality determination unit 1421 determines that there is no abnormality in the remote determination target, the in-vehicle driver 12 is not permitted to drive the remote driving vehicle 10.

The in-vehicle driving permission unit 1422 compares the consciousness level of the remote driver 21 with the consciousness level of the in-vehicle driver 12 when the remote driver 21 performing the remote driving has a sign of abnormality. Then, the driver with a higher consciousness level is permitted to drive the remote driving vehicle 10.

When the remote driving vehicle 10 is performing the autonomous driving at the autonomous driving level 3 in remote manner, the in-vehicle driving permission unit 1422 successively determines whether the remote driver 21 is prepared for taking over the driving operation. When the remote driver 21 is not in a state prepared to take over the driving operation (hereinafter referred to as a driving operation takeover state) but the in-vehicle driver 12 is in the driving operation takeover state, the autonomous driving control execution unit 1423 instructs the continuation of the autonomous driving at the autonomous driving level 3. In this case, the driver scheduled to take over the driving operation is switched to the in-vehicle driver 12.

The in-vehicle driving permission unit 1422 outputs, to the travel control ECU 150, information indicating whether the remote driver 21 or the in-vehicle driver 12 is permitted to perform driving operation. When the in-vehicle driver 12 is not permitted to perform the driving operation, the travel control ECU 150 does not use the value detected by the operation amount detection sensor 151 in travel control. In this case, the travel control ECU performs the remote driving using the driving instruction value transmitted from the remote system 30 to control the traveling of the remote driving vehicle 10.

When the in-vehicle driving permission unit 1422 permits the in-vehicle driving, that is, when switching from the remote driving to the in-vehicle driving, the in-vehicle driving permission unit 1422 outputs a notification indicating the driving switch via the in-vehicle notification unit 130.

The autonomous driving control execution unit 1423 recognizes a travel environment required for executing the autonomous driving by combining detection information acquired from the periphery monitoring sensor 160, the locator information and map data acquired from the locator 170, and traffic congestion information acquired from the on-board communication device 180. The autonomous driving control execution unit 1423 successively determines the current autonomous driving level based on the recognized travel environment and ODD. When the determined autonomous driving level is an autonomous driving level that does not require periphery monitoring obligation, the autonomous driving control execution unit 1423 issues a control command for executing vehicle control to automatically drive the remote driving vehicle 10 based on the recognized travel environment, and successively outputs the control command to the travel control ECU 150. When the determined autonomous driving level is autonomous driving level 3, the autonomous driving control execution unit 1423 sequentially determines whether the driver is prepared to take over driving operation in response to a request from the system.

The driving information acquisition unit 1424 acquires driving information and transmits the acquired driving information from the on-board communication device 180 to the remote system 30. As described above, the driving information includes information indicating the image of periphery area of the remote driving vehicle 10, the vehicle speed of the remote driving vehicle 10, and the steering angle of the remote driving vehicle. The image indicating the periphery area of the remote driving vehicle 10 is successively acquired from the periphery monitoring sensor 160. The vehicle speed and steering angle of the remote driving vehicle 10 are acquired from the travel control ECU 150.

### (Process Executed by Remote Control Device)

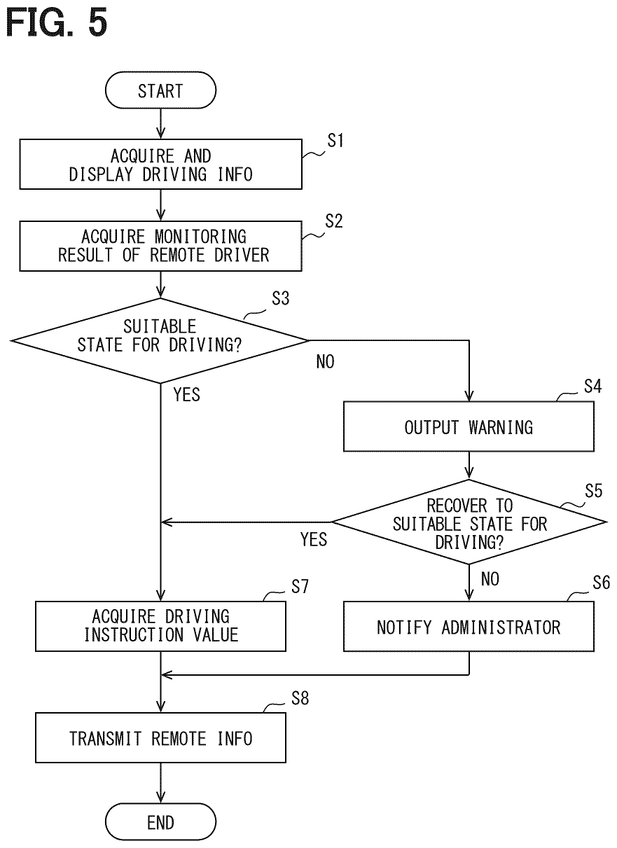

FIG. 5 shows a process executed by the remote control device 36. The remote control device 36 repeatedly executes the process shown in FIG. 5 in the remote driving state. In S1, the driving information acquisition unit 361 acquires driving information transmitted from the vehicle system 100 via the remote communication device 33, and displays the acquired driving information on the display 351. As described above, the driving information includes information indicating the image of periphery area of the remote driving vehicle 10, the vehicle speed of the remote driving vehicle 10, and the steering angle of the remote driving vehicle 10.

The remote driver state notification unit 362 executes S2 to S6. In S2, the monitoring result of the remote driver 21 is acquired from the remote driver monitoring device 32. The monitoring result includes whether the remote driver 21 is in a state suitable for the remote driving and the consciousness level of the remote driver 21.

In S3, the process determines whether the state of remote driver 21 is suitable for the driving based on the result obtained in S2. In response to determining that the remote driver 21 is not in a state suitable for the remote driving, that is, when the determination result in S3 is NO, the process proceeds to S4.

In S4, the process outputs a warning via the remote driver notification device 35. Then, in S5, the monitoring result of remote driver 21 is obtained from the remote driver monitoring device 32, and the process determines whether the remote driver 21 has recovered to a state suitable for the remote driving. When the determination result in S5 is also NO, the process proceeds to S6. In S6, the administrator notification device 34 outputs a notification indicating that the remote driver 21 is in abnormal state.

When the determination result in S3 or the determination result in S5 is YES, the process proceeds to S7. In S7, the driving instruction value acquisition unit 363 acquires the driving instruction value from the remote operation member 31. The remote driver state notification unit 362 and the driving instruction value acquisition unit 363 execute S8. In S8, the remote communication device 33 transmits remote information to the vehicle system 100. The remote information includes whether the remote driver 21 is in a state suitable for remote driving, the consciousness level of the remote driver 21, and the driving instruction value.

### (Process Executed by Vehicle System)

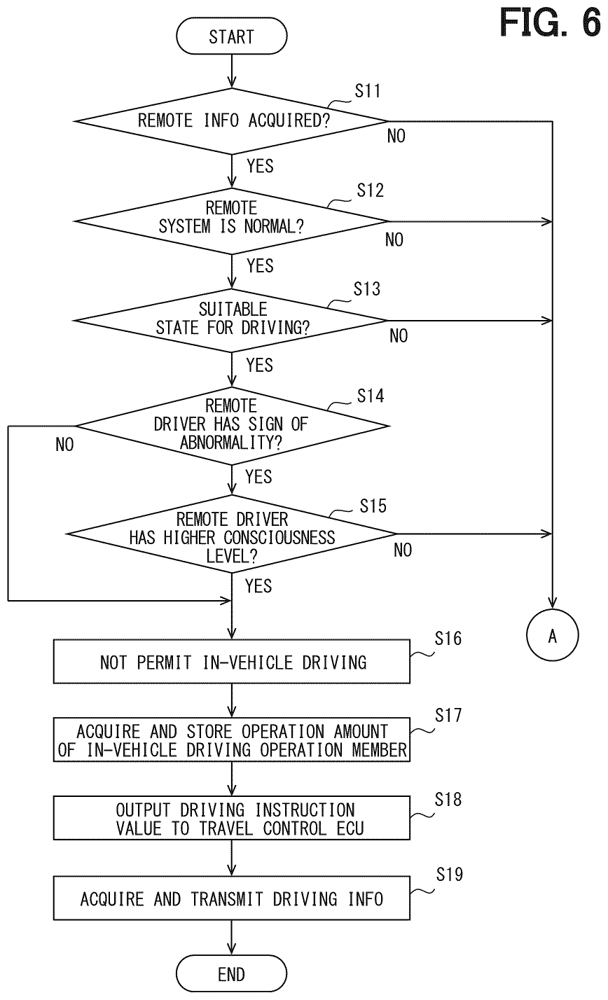

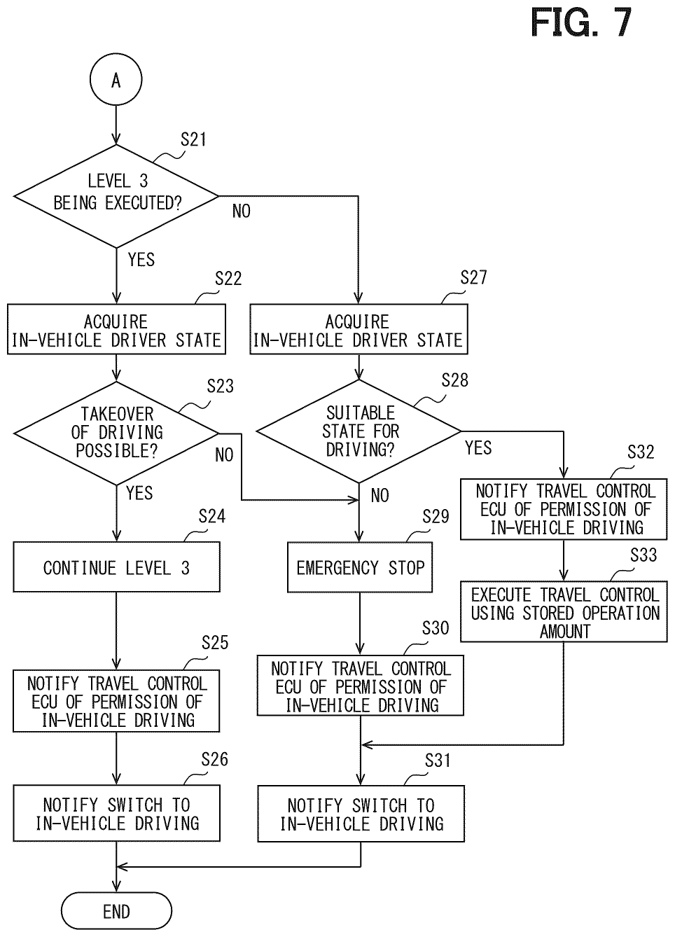

The process executed by the vehicle system 100 when the remote driving vehicle 10 is in remote driving state is shown in FIG. 6 and FIG. 7. In the processes shown in FIG. 6 and FIG. 7, S17 is executed by the travel control ECU 150. Other processes are executed by the autonomous driving ECU 142.

In S11, the remote abnormality determination unit 1421 determines whether the remote information transmitted from the remote system 30 is acquired. When the determination result in S11 is NO, the process proceeds to S21 in FIG. 7. When the determination result in S11 is YES, the process proceeds to S12.

In S12, the remote abnormality determination unit 1421 determines whether the remote system 30 is in normal operation state based on the remote information. When the determination result in S12 is NO, that is, when the remote system 30 is determined to be abnormal, the process proceeds to S21 in FIG. 7. Note that even when the remote information cannot be acquired (S11: NO), the remote system 30 is determined to be abnormal. When the determination result in S12 is YES, the process proceeds to S13.

In S13, the remote abnormality determination unit 1421 determines whether the remote driver 21 is in a state suitable for remote driving based on the remote information. When the determination result in S13 is NO, the process proceeds to S21 in FIG. 7. When the determination result in S13 is YES, the process proceeds to S14.

In S14, the remote abnormality determination unit 1421 determines whether there is a sign of abnormality in the remote driver 21 based on the consciousness level of the remote driver 21. The consciousness level of the remote driver is included in the remote information. When the determination result in S14 is YES, the process proceeds to S15.

In S15, the in-vehicle driving permission unit 1422 compares the consciousness level of the remote driver 21 with the consciousness level of the in-vehicle driver 12. The in-vehicle driving permission unit 1422 determines whether the remote driver 21 has a higher consciousness level than the in-vehicle driver. When the determination result in S15 is NO, the process proceeds to S21 in FIG. 7. When the consciousness level of the remote driver can be compared with the consciousness level of the in-vehicle driver and the consciousness level of the remote driver 21 is higher than that of the in-vehicle driver, the determination result in S15 is YES. When the consciousness level of the in-vehicle driver 12 cannot be acquired, such as when the in-vehicle driver 12 is not seated on the driver seat 11, the determination result in S15 becomes YES. When the determination result in S15 is YES, the process proceeds to S16. When the determination result in S14 is NO, the process also proceeds to S16.

In S16, the in-vehicle driving permission unit 1422 does not permit the in-vehicle driving. In subsequent S17, the travel control ECU 150 acquires the operation amount of in-vehicle driving operation member 13 from the operation amount detection sensor 151. In subsequent S18, the autonomous driving control execution unit 1423 outputs the driving instruction value, which his transmitted from the remote system 30, to the travel control ECU 150. When S18 is executed, the travel control ECU 150 executes travel control based on the driving instruction value transmitted from remote system 30, and does not use the operation amount acquired in S17 in the travel control.

In S19, the driving information acquisition unit 1424 acquires the driving information and transmits the acquired driving information from the on-board communication device 180 to the remote system 30.

The following will describe details of FIG. 7. In the process shown FIG. 7, S33 is executed by the travel control ECU 150. Remaining process is executed by the in-vehicle driving permission unit 1422. In S21, the remote driving vehicle 10 determines whether the autonomous driving level 3 is being executed. When the autonomous driving level 3 is being executed, the determination result in S21 becomes YES and the process proceeds to S22.

In S22, the state of in-vehicle driver 12 is acquired from the in-vehicle driver monitoring device 120. Note that, before executing S22, the in-vehicle notification unit 130 may notify that the driving operation is to be switched to the in-vehicle driving. In S23, the process determines whether the in-vehicle driver 12 is prepared to take over the driving operation in response to a request from the autonomous driving system 140. When the process determines YES in S23, the process proceeds to S24.

In S24, the driver to be notified of the driving takeover is switched to the in-vehicle driver 12, and the autonomous driving level 3 is continued. Then, in S25, the travel control ECU 150 is notified that the in-vehicle driving is permitted. Thus, the in-vehicle driver 12 can override the driving operation of vehicle during execution of autonomous driving state at level 3. In S26, the in-vehicle notification unit 130 notifies that the driving mode is switched to the in-vehicle driving. Thus, the in-vehicle driver 12 can recognize that the in-vehicle driving becomes possible.

When the determination result in S21 is NO, the process proceeds to S27. When proceeding to S27, the remote driving vehicle 10 is being remotely driven at an autonomous driving level of 2 or lower. In S27, the process acquires the state of in-vehicle driver 12 from the in-vehicle driver monitoring device 120, similar to S22. Similar to S22, before executing S27, the in-vehicle notification unit 130 may notify the switch of driving mode to the in-vehicle driving.

In S28, the process determines whether the in-vehicle driver 12 is in a state suitable for in-vehicle driving. When the determination result in S28 is NO, the process proceeds to S29. When the determination result in S23 is NO, the process also proceeds to S29. In S29, the travel control ECU 150 is instructed to make an emergency stop of the remote driving vehicle 10. Then, in S30, the travel control ECU 150 is notified of permission of in-vehicle driving. After emergency-stopping the remote driving vehicle 10, the travel control ECU 150 automatically shifts to the in-vehicle driving mode in which the remote driving vehicle 10 moves based on the operation made on the in-vehicle driving operation member 13.

In S31, the in-vehicle notification unit 130 notifies that the driving mode has been switched to in-vehicle driving. The notification content in S31 is different from that in S26. In S31, the autonomous driving level is set to be level 2 or lower. Therefore, the notification in S31 is made such that the user can recognize the notification in S31 has higher emergency than the notification made in S26. For example, the notification in S31 may have a volume higher than that of the notification made in S26, or may output an image more conspicuous than the image output in notification of S26.

When the determination result in S28 is YES, the process proceeds to S32. In S32, the travel control ECU 150 is notified of permission to the in-vehicle driving. In S33, the travel control is executed using the latest operation amount stored in S17. Then, the process proceeds to S31 described above, and the in-vehicle notification unit 130 notifies that the driving mode has been switched to the in-vehicle driving.

### Summary of First Embodiment

In the first embodiment described above, when there is an abnormality in the remote determination target (S11 to S13: NO), the in-vehicle driving is permitted (S25, S30, S32). Therefore, even when there is an abnormality in the remote determination target, the remote driving vehicle 10 can continue traveling by the in-vehicle driving.

The in-vehicle driving permission unit 1422 does not permit the in-vehicle driving when the remote abnormality determination unit 1421 determines that the remote driver 21 and the remote system 30 are not abnormal (S16). Thus, during the remote driving, it is possible to prevent the in-vehicle driver 12 from performing the driving operation that the remote driver 21 does not intend.

The travel control ECU 150 sequentially acquires and stores signals indicating the operation amount of the in-vehicle driving operation member 13 even when the in-vehicle driving permission unit 1422 does not permit the in-vehicle driving (S17). With this configuration, when the in-vehicle driving permission unit 1422 permits the in-vehicle driving, travel control can be performed based on the stored operation amount. When the in-vehicle driver 12 senses an abnormality in the remote determination target and operates the in-vehicle driving operation member 13 before the in-vehicle driving is permitted, the remote driving vehicle 10 is driven by reflecting the driving operation made by the in-vehicle driver. Thus, the in-vehicle driver 12 can drive the remote driving vehicle 10 while quickly responding to the abnormality determined in the remote determination target.

When there is a sign of abnormality in the remote driver 21 (S14: YES) and the consciousness level of the in-vehicle driver 12 is determined, the in-vehicle driving permission unit 1422 permits the driving operation to the driver who has the higher consciousness level between the in-vehicle driver 12 and the remote driver 21 (S15). With this configuration, it is possible to prevent a driver with a low consciousness level from performing the driving operation of the remote driving vehicle 10.

The in-vehicle driving permission unit 1422 permits the in-vehicle driving (S25) when the remote abnormality determination unit 1421 determines an abnormality in the remote determination target (S11 to S13: NO) during the remote driving at autonomous driving level 3. When the in-vehicle driver 12 is prepared to take over the driving operation (S23: YES), the driver to be notified of the takeover of driving operation is switched to the in-vehicle driver 12, and the driving at autonomous driving level 3 is continued. (S24). As a result, even when there is an abnormality in the remote determination target, the autonomous driving level 3 can be continued.

When the remote abnormality determination unit 1421 determines that there is an abnormality in the remote determination target (S11 to S13: NO) and the autonomous driving level is level 2 or lower (S21: NO), the in-vehicle driving permission unit 1422 stops the remote driving vehicle 10 (S29) first. Thereafter, the in-vehicle driving is permitted. When the in-vehicle driving operation member 13 is operated by the in-vehicle driver, the remote driving vehicle 10 automatically shifts to the in-vehicle driving mode (S30). Thus, after the remote driving vehicle 10 made an emergency stop, the in-vehicle driver 12 can drive the remote driving vehicle 10 by operating the in-vehicle driving operation member 13 without performing an operation to switch the driving mode to the in-vehicle driving.

When the remote abnormality determination unit 1421 determines that there is an abnormality in the remote determination target (S11 to S13: NO), the in-vehicle driving permission unit 1422 notifies the in-vehicle notification unit 130 that the driving-mode is to be switched to the in-vehicle driving (S26, S31). Thus, the occupant of remote driving vehicle 10 can recognize that the vehicle is switched to the in-vehicle driving.

When an abnormality is determined to be occurred in the remote determination target by the in-vehicle driving permission unit 1422, the notification content corresponding to the execution of autonomous driving level 3 (S26) is set to be different from the notification content corresponding to the execution of autonomous driving level 2 or lower (S31). Specifically, when autonomous driving level 2 or lower is being executed, the notification is performed to make the driver recognize that the situation is more urgent (S31) than the notification corresponding to autonomous driving level 3. Thus, when the autonomous driving level 2 or lower is to be executed, there is a high possibility that the occupant in the remote driving vehicle 10 can quickly respond to the travel control at the autonomous driving level 2 or lower.

Based on a fact that the remote driver 21 is not in a state suitable for remote driving, the administrator notification device 34 notifies the administrator that the remote driver 21 is not in a state suitable for driving. This enables the remote driving facility 20 to quickly take measures such as replacing of the remote driver 21.

### Second Embodiment

In a remote driving system 5 of vehicle according to the second embodiment shown in FIG. 8, one remote system 30 manages operations of multiple remote driving vehicles 10. The remote driving system 5 of vehicle includes multiple infrastructure systems 60 in addition to the remote system 30 and the multiple remote driving vehicles 10.

In the remote driving facility 20 where the remote system 30 is installed, one or more remote administrators 25 and two or more remote drivers 21 are engaged in operating the remote driving vehicles 10. The remote administrator 25 manages the multiple remote driving vehicles 10 under the control of the remote system 30. The remote driver 21 remotely controls each remote driving vehicle 10 by monitoring each remote driving vehicle 10 and taking over a dynamic driving task from the autonomous driving system 140 when necessary. One remote driver 21 may correspond to a main remote operator 22. The main remote operator 22 preferentially performs remote driving of the remote driving vehicle 10 when an abnormality occurs in the remote driving vehicle 10. Another remote driver 21 may correspond to a sub remote operator 23. The sub remote operator 23 remotely drives the remote driving vehicle 10 instead of the remote driver 21 when there is an abnormality in the main remote operator 22 or when abnormalities occurs in multiple remote driving vehicles 10.

Similar to the first embodiment, the remote driving vehicle 10 can perform autonomous driving at the autonomous driving level 3 while being remotely monitored by the remote driver 21. The remote driving vehicle 10 is an unmanned, automatically driving vehicle that can travel without a driver on board. When the remote driving vehicle 10 is a mobility service vehicle, all occupants 14 in the remote driving vehicle 10 are passengers. The remote driving vehicle 10 can switch the travel control among multiple modes, which includes at least (i) an autonomous driving mode in which the vehicle performs the autonomous driving while being remotely monitored, (ii) a remote control mode in which the remote driver 21 remotely controls the vehicle, and (iii) an in-vehicle driving mode in which the vehicle is operated by the in-vehicle driver 12. The current travel control mode of remote driving vehicle 10 may be displayed on an external display unit 135 mounted on the remote driving vehicle 10, and is notified to pedestrians, cyclists, drivers, who exist around the remote driving vehicle 10.

The infrastructure system 60 includes a monitoring camera 61. The infrastructure system 60 is installed along a travel route of the remote driving vehicle 10. A large number of infrastructure systems 60 may be installed so that the entire travel routes of the remote driving vehicles 10 can be photographed without exception. Alternatively, the infrastructure systems may be installed along the travel route only at specific points, such as preset stops and intersections.

The infrastructure system 60 is capable of communicating with the remote system 30 via a public communication network. The infrastructure system 60 transmits the monitoring video of travel route taken by the monitoring camera 61 to the remote system 30 as infrastructure information. The infrastructure system 60 may include an infrastructure sensor different from the monitoring camera 61. The detection information detected by the infrastructure sensor may be transmitted from the infrastructure system 60 to the remote system 30 as the infrastructure information.

### (Configuration of Remote System)

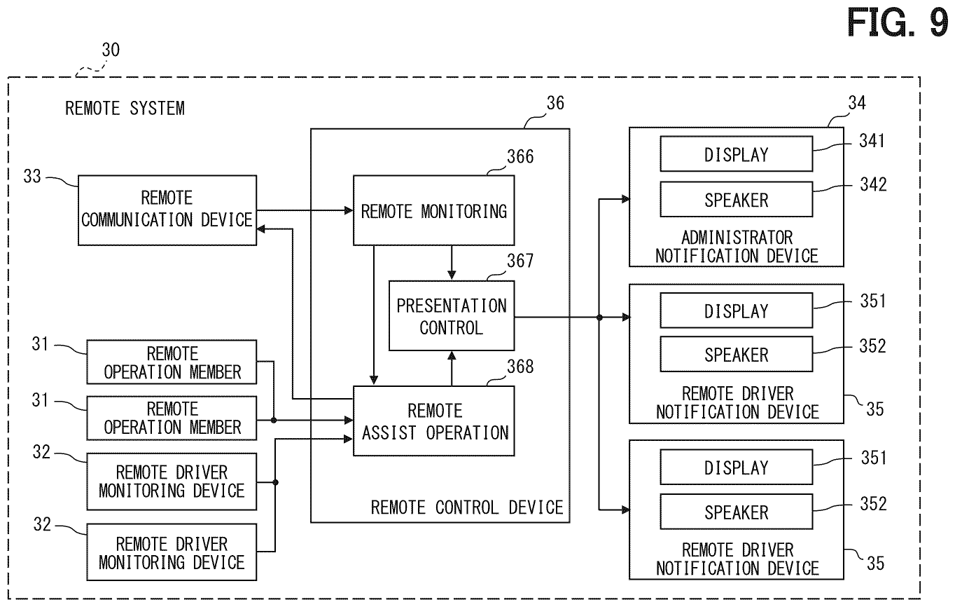

Similar to the first embodiment, a remote system 30 of the second embodiment shown in FIG. 8 and FIG. 9 includes a remote operation member 31, a remote driver monitoring device 32, a remote communication device 33, an administrator notification device 34, a remote driver notification device 35, and a remote control device 36. Two remote operation members 31, two remote driver monitoring devices 32, and two remote driver notification devices 35 are respectively provided for the main remote operator 22 and the sub remote operator 23.

The remote driver monitoring device 32 or the remote driver notification device 35 performs an identification process to determine whether the remote driver 21 is a registered authorized person. The identification process may be a face authentication process using the remote driver monitoring device 32, or may be an ID and password authentication process that requires input of ID and password on the remote driver notification device 35. Through such identification process, only authorized person who has been successfully authenticated can perform remote monitoring and remote driving as the remote driver 21. The administrator notification device 34 may perform the identification process to determine whether the remote administrator 25 is an authorized person.

The remote control device 36 functions as a remote monitoring unit 366, a presentation control unit 367, and a remote assist operation unit 368, by executing a program stored in a non-volatile memory.

The remote monitoring unit 366 includes the function corresponding to driving information acquisition unit 361 (see FIG. 2) of the first embodiment. The remote monitoring unit 366 sequentially acquires operation information and infrastructure information, which are received by the remote communication device 33. The driving information is information necessary for remote monitoring and remote driving of the remote driving vehicle 10, and is transmitted from each remote driving vehicle 10. The infrastructure information is a real-time monitoring video of the travel route of the remote driving vehicle 10, and is transmitted from each infrastructure system 60.

The presentation control unit 367 has the function of remote driver state notification unit 362 (see FIG. 2) of the first embodiment. The presentation control unit 367 controls presentation of information to the remote administrator 25 on the administrator notification device 34 and presentation of information to the main remote operator 22 and the sub remote operator 23 on the respective remote driver notification devices 35. Specifically, the presentation control unit 367 displays the driving information and infrastructure information acquired by the remote monitoring unit 366 on each of the displays 341 and 351. As a result, each display 341, 351 displays at least the video captured by the camera unit 161 (see FIG. 3) and the video captured by the monitoring camera 61.

The presentation control unit 367 recognizes, through the remote assist operation unit 368, that an abnormality of the remote driver 21 is detected. When the presentation control unit 367 detects an abnormality in the remote driver 21, the presentation control unit 367 controls the remote driver notification device 35 to issue a warning. When an abnormality is detected in the main remote operator 22, the presentation control unit 367 outputs the warning from the remote driver notification device 35 of the main remote operator 22, and also outputs the warning from the remote driver notification device 35 of the sub remote operator 23 and the administrator notification device 34. When an abnormality is detected in the sub remote operator 23, the presentation control unit 367 outputs the warning from the remote driver notification device 35 of the sub remote operator 23, and also outputs the warning from the remote driver notification device 35 of the main remote operator 22 and the administrator notification device 34.

The remote assist operation unit 368 has the function of driving instruction value acquisition unit 363 (see FIG. 2) of the first embodiment. When an abnormality occurs in a specific remote driving vehicle 10 among the multiple remote driving vehicles 10 under the management of remote system 30, the remote assist operation unit 368 remotely detects the occurrence of abnormality in the specific remote driving vehicle 10 via the remote communication device 33 and the remote monitoring unit 366. The remote assist operation unit 368 starts remote driving in cooperation with the vehicle system 100 in response to the determination of abnormality occurrence in the specific remote driving vehicle 10. In this case, the remote assist operation unit 368 determines which of the main remote operator 22 and the sub remote operator 23 is to be set as the remote driver 21, and acquires driving instruction value from the remote operation member 31 corresponding to the set remote driver 21. The remote assist operation unit 368 transmits, via the remote communication device 33, the acquired driving instruction value to the specific remote driving vehicle 10 in which the abnormality is occurred.

Further, the remote assist operation unit 368 acquires the monitoring result of remote driver 21 from the remote driver monitoring device 32. As described above, when an abnormality occurs in the remote driver 21, the remote assist operation unit 368 cooperates with the presentation control unit 367 and issues a warning to the remote driver 21 using the remote driver notification device 35. When the abnormal state of the remote driver 21 does not improve even after the output of warning, the remote assist operation unit 368 confirms that the remote driver 21 is in the abnormal state.

Based on the confirmed determination of abnormal state of the remote driver, the remote assist operation unit 368 notifies each remote driving vehicle 10 via the remote communication device 33 that an abnormality is occurred in the remote driver 21. As an example, when an abnormality occurred in the main remote operator 22 is confirmed, the remote assist operation unit 368 transmits information (hereinafter referred to as replacement information) indicating that the authority of remote driving has been transferred to the sub remote operator 23, to each remote driving vehicle 10. When an abnormality of the main remote operator 22 or the sub remote operator 23 is confirmed, the remote assist operation unit 368 transmits, to each remote driving vehicle 10, information indicating existence of an auxiliary remote operator 21 (hereinafter referred to as a substitute) who can take over the remote driving.

### (Configuration of Vehicle System)

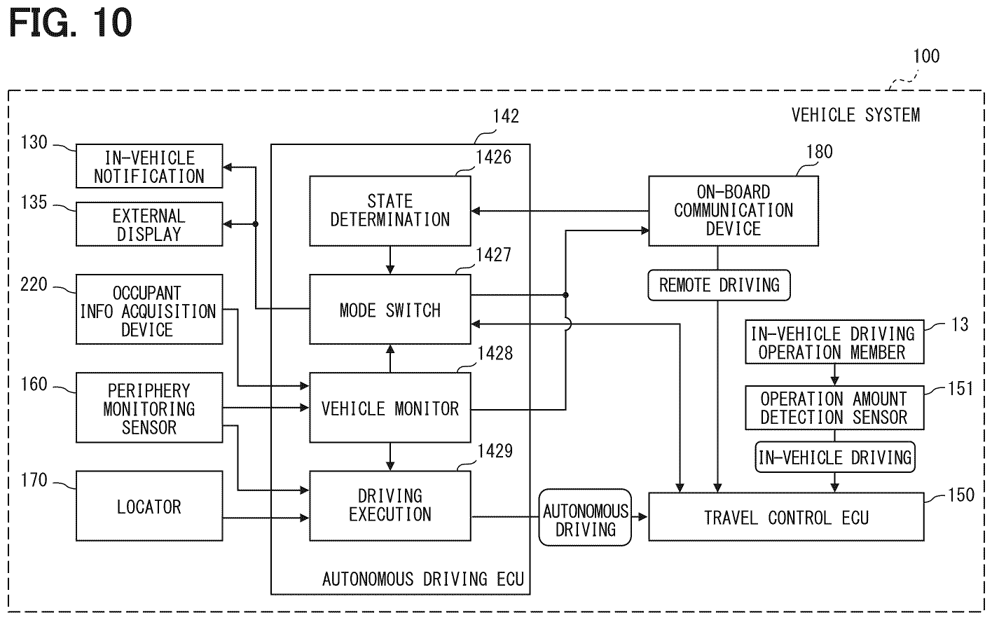

Similar to the first embodiment, a vehicle system 100 of the second embodiment shown in FIG. 8 and FIG. 10 includes an in-vehicle notification unit 130, a travel control ECU 150, a periphery monitoring sensor 160, a locator 170, an on-board communication device 180, and an autonomous driving ECU 142. In addition, the vehicle system 100 further includes an occupant information acquisition device 220 and an external display unit 135.

The occupant information acquisition device 220 has the function of in-vehicle driver monitoring device 120 (see FIG. 3) of the first embodiment. The occupant information acquisition device 220 monitors the inside of compartment (interior) of the remote driving vehicle 10, and detects the occurrence of a sudden sickness, an injured person, or the like. When the in-vehicle driver 12 is in driving state, the occupant information acquisition device 220 sequentially monitors whether the in-vehicle driver 12 is in a state suitable for driving.

The occupant information acquisition device 220 acquires occupant information of a specific occupant 14 (hereinafter referred to as specific occupant 14s) who sits in the driver seat 11 and attempts to operate the in-vehicle driving operation member 13 when the in-vehicle driving is permitted. As an example, the occupant information acquisition device 220 captures images of a face of the specific occupant 14s and the driver license presented by the specific occupant 14s, and obtains a face image and a license image of the specific occupant. The face image and the license image are used as occupant information of the specific occupant 14s, and are transmitted to the remote system 30 via the autonomous driving ECU 142 and the on-board communication device 180.

The external display unit 135 displays information toward outside of the remote driving vehicle 10. For example, the external display unit 135 is capable of displaying characters, or is configured to display information by changing the light illumination mode. The remote driving vehicle 10 is provided with at least one of a front display unit 136, a lateral display unit 137, or a rear display unit 138, as the external display unit 135. The front display unit 136 is installed at the front portion of the remote driving vehicle 10 with the display surface facing forward of the remote driving vehicle 10. The lateral display units 137 is installed on both left and right portions of the remote driving vehicle 10, respectively. The rear display unit 138 is installed at the rear surface of the remote driving vehicle 10 with the display surface facing rearward of the remote driving vehicle 10.

The autonomous driving ECU 142 has the function of a remote monitoring operation. The autonomous driving ECU 142 includes, as functional units, a state determination unit 1426, a mode switching unit 1427, a vehicle monitoring unit 1428, and a driving execution unit 1429, by executing a program with the processing unit 143 (see FIG. 3).

The state determination unit 1426 has the function of the remote abnormality determination unit 1421 (see FIG. 4) of the first embodiment. The state determination unit 1426 continuously monitors the remote determination target based on information received by the on-board communication device 180 from the remote system 30. When the state determination unit 1426 determines that an abnormality has occurred in the remote determination target, the state determination unit 1426 shares information about abnormality occurrence with the mode switching unit 1427. The abnormality to be determined in the remote determination target includes either of the two remote drivers 21 has abnormality or sign of abnormality and the communication between the remote driving vehicle and the remote system 30 has an abnormality. The communication abnormality include not only deterioration of the communication state but also hijacking of communication (session hijacking) by an unauthorized third party. When the state determination unit 1426 determines that the abnormality is resolved or that the abnormality is a false detection, the state determination unit shares information about resolution of abnormality with the mode switching unit 1427.

The mode switching unit 1427 has the function of in-vehicle driving permission unit 1422 (see FIG. 4) of the first embodiment. The mode switching unit 1427 cooperates with the travel control ECU 150 to switch the travel control state of the vehicle system 100 among multiple modes, which include the above-described autonomous driving mode, remote control mode, and in-vehicle driving mode.

The mode switching unit 1427 switches the travel control state from the autonomous driving mode to the remote control mode when the driving execution unit 1429 cannot continue the autonomous driving at autonomous driving level 3 or higher. The mode switching unit 1427 determines to interrupt the autonomous driving mode based on the interruption proposal presented by the vehicle monitoring unit 1428, and switches the driving mode to the remote control mode. In this case, the mode switching unit 1427 transmits an operation request for remote driving, that is, a request for performing remote driving, to the remote system 30 via the on-board communication device 180.

When information indicating occurrence of abnormality is provided from the state determination unit 1426 and an abnormality is determined in the remote determination target, the mode switching unit 1427 switches the travel control mode from the remote control mode to the in-vehicle driving mode, similar to the first embodiment. In the second embodiment, when there is no abnormality in the remote determination target, the mode switching unit 1427 does not switch to the in-vehicle driving mode.

According to the above mode switch, when the travel control state is the autonomous driving mode, the travel control ECU 150 controls the remote driving vehicle 10 to travel based on the control command input from the driving execution unit 1429. When the travel control state is the remote control mode, the travel control ECU 150 controls the remote driving vehicle 10 to travel based on the driving instruction value transmitted from the remote system 30 and received by the on-board communication device 180. When the travel control state is the in-vehicle driving mode, the travel control ECU 150 controls the remote driving vehicle 10 to travel based on the driving instruction value input from the operation amount detection sensor 151.

When the mode switching unit 1427 switches the travel control state, the autonomous driving ECU 142 and the travel control ECU 150 always temporarily stops the remote driving vehicle 10. In the stopped state of the remote driving vehicle 10, the mode switching unit 1427 executes start process and termination process of the remote control mode or the in-vehicle driving mode. As a result, the takeover of driving operation between the autonomous driving ECU 142 and the remote driver 21 and the takeover of driving operation between the remote driver 21 and the in-vehicle driver 12 are carried out in the stop state of the remote driving vehicle 10.

The mode switching unit 1427 controls information notification executed by the in-vehicle notification unit 130 and the external display unit 135. When switching the travel control state, the mode switching unit 1427 uses the in-vehicle notification unit 130 to notify the occupant 14 of the mode switch before the remote driving vehicle 10 stops. The mode switching unit 1427 displays the current travel control state on the external display unit 135.

The vehicle monitoring unit 1428 has the function of driving information acquisition unit 1424 (see FIG. 4) of the first embodiment. The vehicle monitoring unit 1428 acquires various information indicating the external environment, the internal environment, and the state of remote driving vehicle 10. The vehicle monitoring unit 1428 monitors the acquired information. The vehicle monitoring unit 1428 acquires an image indicating the periphery of remote driving vehicle 10 from the camera unit 161 (see FIG. 3), and successively transmits the image to the remote system 30 via the on-board communication device 180 together with information indicating the travel state of remote driving vehicle 10.

The vehicle monitoring unit 1428 makes a proposal to the mode switching unit 1427 to interrupt the autonomous driving mode based on the detection information of periphery monitoring sensor 160. In response to detecting an obstacle that is difficult to be recognized or difficult to be avoided on the planned travel route of the remote driving vehicle 10, or in response to the detection ability of periphery monitoring sensor 160 being significantly reduced due to deterioration of the weather condition, the vehicle monitoring unit 1428 proposes interruption of the autonomous driving mode.

The vehicle monitoring unit 1428 obtains the condition of occupant 14 based on information acquired from the occupant information acquisition device 220. When the occupant information acquisition device 220 detects an abnormality of the occupant 14, the vehicle monitoring unit 1428 requests the driving execution unit 1429 to make a temporary stop of the remote driving vehicle 10, and reports the occurrence of abnormality in the compartment via the on-board communication device 180 to the remote system 30.

The driving execution unit 1429 has the functions of autonomous driving control execution unit 1423 (see FIG. 4) of the first embodiment. The driving execution unit 1429 recognizes the driving environment based on (i) the detection information acquired from the periphery monitoring sensor 160 and (ii) the locator information and map data acquired from the locator 170. The driving execution unit 1429 executes the autonomous driving in the autonomous driving mode. The driving execution unit 1429 generates control command for executing vehicle control for automatically driving the remote driving vehicle 10 based on the recognized driving environment, and sequentially outputs the generated control command to the travel control ECU 150. The driving execution unit 1429 is capable of executing the autonomous driving control at the autonomous driving level of 4 or higher, or is capable of executing driving assist control at the autonomous driving level lower than level 3.

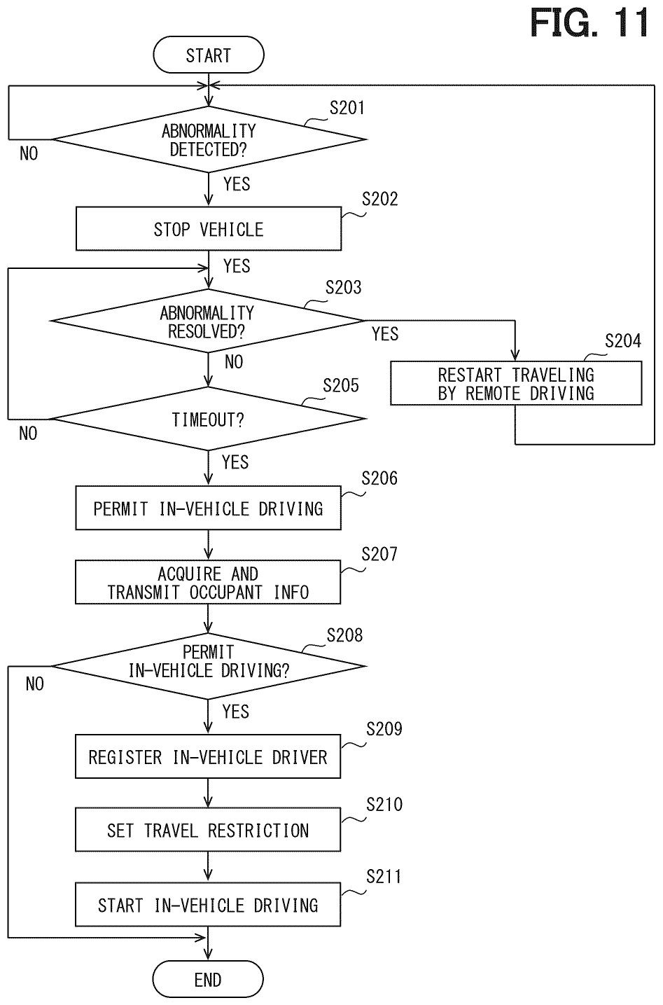

The following will describe details of each process executed by the autonomous driving ECU 142 with reference to FIG. 11 to FIG. 13.

### (Mode Switch Process Executed in Response to Abnormality Detection in Remote Determination Target)

When starting the remote control mode, the autonomous driving ECU 142 executes the process shown in FIG. 11 (hereinafter referred to as remote abnormality handling process), and prepares for the occurrence of abnormality in the remote determination target. In S201 of the remote abnormality handling process, the state determination unit 1426 determines whether an abnormality is detected in the remote determination target. In S201, the state determination unit 1426 allows false detection of an abnormality, and detects not only definite abnormality but also an abnormality with low detection accuracy. When the determination result in S201 is NO, the state determination unit 1426 repeats the abnormality detection in S201. When the determination result in S201 is YES, the process proceeds to S202. In S202, that is, when an abnormality is detected in the remote determination target, the travel control ECU 150 stops the remote driving vehicle 10 based on a command from the mode switching unit 1427 or from the driving execution unit 1429.

In S203, the state determination unit 1426 determines whether the abnormality detected in S201 has been resolved. When the vehicle system 100 has resolved the abnormality, or when any one of the occupants 14, the remote driver 21, or remote administrator 25 performs a resolution process to resolve the abnormality, the state determination unit 1426 determines that the abnormality is resolved. When the determination result in S203 becomes YES, the process proceeds to S204. In S203, when the abnormality detected in S201 is confirmed as a false detection, the process proceeds to S204.

In S204, the mode switching unit 1427 determines to continue the remote operation mode and permits restart of remote driving. Thus, the travel control ECU 150 can restart travel by remote operation based on the driving instruction value for remote driving. In this case, the process returns to S201, and the state determination unit 1426 continues to determine whether abnormality is detected or not. According to the above configuration, even when the remote driving vehicle 10 stops due to a false detection of abnormality, the remote driving vehicle can restart travel in response to confirming that the detected abnormality is a false detection.

When the determination result in S203 is NO, the state determination unit 1426 determines a timeout in S205. The state determination unit 1426 waits for the abnormality to be resolved for an elapse of predetermined period, that is, timeout. When the timeout occurs without the abnormality being resolved, that is, the determination result in S205 is YES, the mode switching unit 1427 determines to terminate the remote operation mode in S206. The mode switching unit 1427 switches the travel control state from the remote operation mode to the in-vehicle driving mode in S206, thereby permitting the in-vehicle driving.

When the in-vehicle driving is permitted, the vehicle monitoring unit 1428 cooperates with the occupant information acquisition device 220 to acquire occupant information regarding the specific occupant 14s seated in the driver seat 11 in S207. The vehicle monitoring unit 1428 provides the acquired occupant information to the remote system 30 by transmitting the acquired occupant information. The occupant information is displayed on the displays 341 and 351 by the remote system 30, and is presented to the remote driver 21 or the remote administrator 25. The remote driver 21 or the remote administrator 25 determines whether to permit the specific occupant 14s to perform the in-vehicle driving based on the displayed occupant information, and inputs the determination result into the remote system 30. As an example, the remote driver 21 or the remote administrator 25 may permit the in-vehicle driving in response to determining that the specific occupant 14s is the holder of the driver license based on the face image on the driver license and the face image of the specific occupant 14s. The determination result made by the remote system 30 is transmitted to the autonomous driving ECU 142.

In S208, the mode switching unit 1427 further determines, based on the occupant information, whether to permit the specific occupant 14s to perform the in-vehicle driving. In S208, the mode switching unit 1427 determines whether to permit the specific occupant 14s to perform the in-vehicle driving, based on the determination result of the occupant information. The determination result of the occupant information is obtained from the remote system 30. When the communication with the remote system 30 is interrupted, the mode switching unit 1427 may determine whether to permit the in-vehicle driving using occupant information without using information from the remote system. In this case, the mode switching unit 1427 permits the specific occupant 14s to perform the in-vehicle driving when the face image on the driver's license is same as the face image of specific occupant 14s. When the determination result in S208 is NO, the remote abnormality handling process is ended. In this case, the remote driving vehicle 10 maintains the stop state for standby. When the determination result in S208 is YES, the process proceeds to S209.

In S209, the vehicle monitoring unit 1428 registers the specific occupant 14s as the in-vehicle driver 12. In this case, the occupant information of the specific occupant 14s is stored in at least one of the remote control device 36 or the autonomous driving ECU 142.

In S210, the mode switching unit 1427 and the travel control ECU 150 set travel restrictions. When the mode switching unit 1427 permits the in-vehicle driving, the travel speed of the remote driving vehicle 10 is limited compared with when the remote driving vehicle 10 travels by the remote driving. As an example, when the remote driving vehicle 10 is a vehicle that travels on a local road, the travel speed is limited to about half the speed limit of the local road (about 30 km/h). When the remote driving vehicle 10 is a low-speed vehicle, the travel speed is limited to 5 to 10 km/h. In S211, the mode switching unit 1427 starts the in-vehicle driving. The travel control ECU 150 controls the remote driving vehicle 10 to restart traveling based on the driving instruction value of in-vehicle driving. Then, the remote abnormality handling process is ended.

### (External Display Process of Travel Control State]

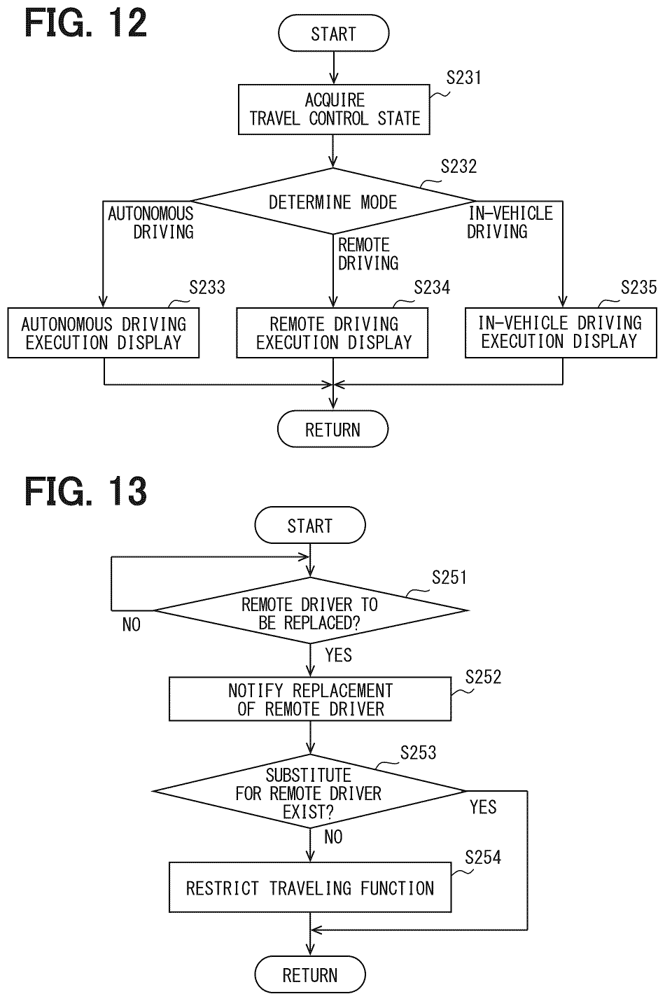

The mode switching unit 1427 executes a process shown in FIG. 12 (hereinafter referred to as external display process) in response to an activation of vehicle system 100. The mode switching unit 1427 continues the external display process until the power of vehicle system 100 is turned off. In the external display process, driving state information indicating whether the remote driving vehicle 10 is performing autonomous driving, remote driving, or in-vehicle driving is continuously displayed on the external display unit 135.

In S231, the external display process acquires the travel control state. In S232, the current driving mode is determined based on the travel control state acquired in S231. When the travel control state is the autonomous driving mode, the process proceeds to S233. In S233, the mode switching unit 1427 displays, on the external display unit 135, text or an image toward outside of the vehicle as an autonomous driving execution display indicating that the remote driving vehicle 10 is executing the autonomous driving. When the travel control state is the remote driving mode, the process proceeds to S234. In S234, the mode switching unit 1427 displays, on the external display unit 135, text or an image indicating that the remote driving vehicle 10 is executing the remote driving as a remote driving execution display. When the travel control state is the in-vehicle driving mode, the process proceeds to S235. In S235, the mode switching unit 1427 displays, on the external display unit 135, text or an image indicating that the remote driving vehicle 10 is executing the in-vehicle driving as an in-vehicle driving execution display.

The autonomous driving mode is a travel control state in which the remote driving vehicle 10 is traveling without any abnormality. Therefore, the mode switching unit 1427 may not perform the autonomous driving execution display. The mode switching unit 1427 may use the external display unit 135 to display only the remote driving execution display and the in-vehicle driving execution display.

### (Vehicle Process Executed in Response to Abnormality in Remote Driver]

The mode switching unit 1427 executes a process shown in FIG. 13 (hereinafter referred to as vehicle process) in response to start of the remote driving mode. In the vehicle process, the autonomous driving ECU 142 remotely monitors the condition of remote driver 21. In S251 of the vehicle process, the mode switching unit 1427 cooperates with the state determination unit 1426 to acquire the abnormality of remote driver 21 in the remote driving facility 20. In S251, the mode switching unit 1427 determines the presence or absence of replacement information indicating replacement of the remote driver 21 in the remote driving facility 20. When there is no replacement information, the process repeats S251. When the replacement information is acquired from the remote system 30, the mode switching unit 1427 uses the in-vehicle notification unit 130 to provide notification about the replacement information in S252.

In S253, the mode switching unit 1427 cooperates with the state determination unit 1426 to determine whether there is a replacement person for remote operation. As an example, when there is an abnormality in the main remote operator 22 and the remained remote driver 21 is only the sub remote operator 23, that is, when there are no multiple remote drivers 21 other than the main remote operator 22 in the remote driving facility 20, the mode switching unit 1427 determines that there is no substitute in S253 (S253: NO). When there is an abnormality in the main remote operator 22 but another remote driver 21 other than the sub remote operator 23 is present in the remote driving facility 20, the mode switching unit 1427 determines that there is a substitute in S253 (S253: YES).

When the determination result in S253 is YES, the process returns to S251 and the vehicle process is repeated. When the determination result in S253 is NO, in S254, the mode switching unit 1427 cooperates with the travel control ECU 150 restrict partial traveling functions of the remote driving vehicle 10 during the remote driving state. In response to determining that there is no substitute for the remote driving, the mode switching unit 1427 may set the upper limit of travel speed of remote driving vehicle 10 lower than compared when there is a substitute for the remote driving. The mode switching unit 1427 may apply restriction such as prohibiting a lane change to an overtaking lane, or permitting only the door open operation while forbidding traveling of the remote driving vehicle 10.

The mode switching unit 1427 may perform the vehicle process even when the vehicle is traveling in the autonomous driving mode. In this case, in consideration of a decrease in monitoring ability of the remote driver 21, the mode switching unit 1427 may limit the autonomous driving function of the driving execution unit 1429.

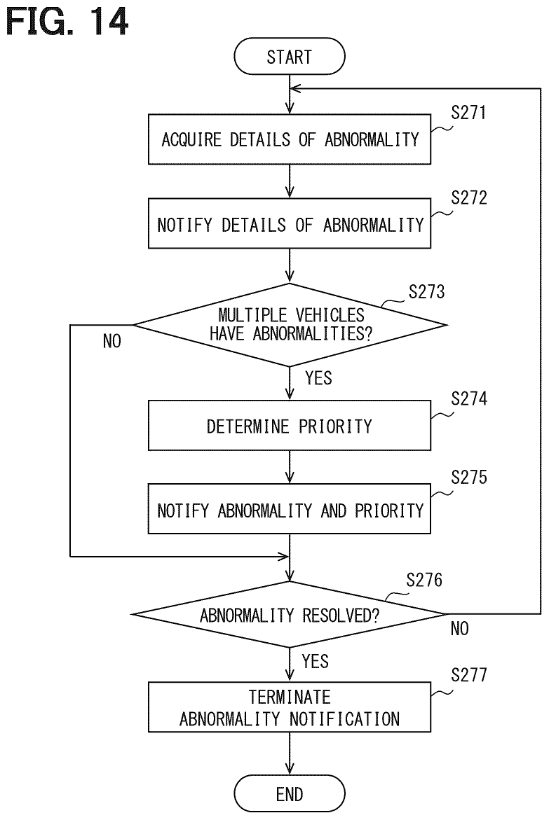

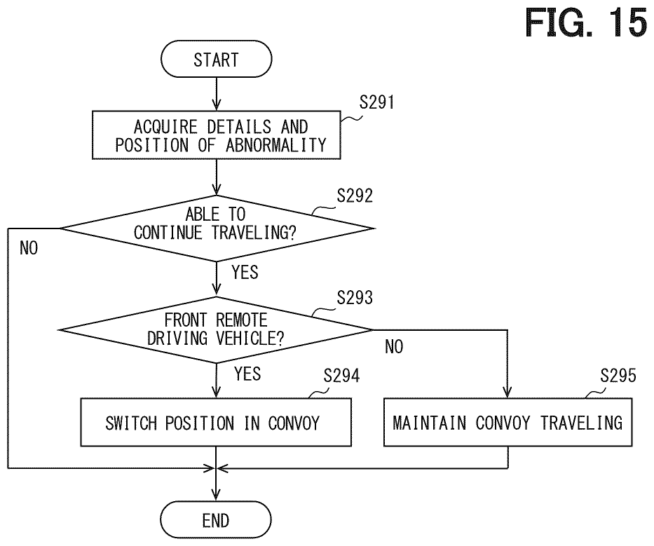

The following will describe details of each process executed by the remote system 30 with reference to FIG. 14 and FIG. 15.

### (Remote Handling Process in Response to Simultaneous Occurrence of Multiple Abnormalities)

When the remote control device 36 receives a notification indicating an occurrence of abnormality from one of the multiple remote driving vehicles 10 under the management of the remote system 30, the remote control device 36 executes the process shown in FIG. 14 (hereinafter referred to as a vehicle abnormality handling process). The remote control device 36 prepares for simultaneous occurrence of abnormalities in multiple remote driving vehicles 10 by executing the vehicle abnormality handling process.

In S271 of the vehicle abnormality handling process, the remote monitoring unit 366 acquires details of the abnormality that has occurred in one remote driving vehicle 10. In S271, the remote monitoring unit 366 further determines whether a request to perform the remote driving is acquired from the remote driving vehicle 10. In S272, the presentation control unit 367 notifies the remote driver 21 and the remote administrator 25 of the details of abnormality detected in S271.

In S273, the remote monitoring unit 366 determines whether a request to perform the remote driving is acquired from another remote driving vehicle 10. When the determination result in S273 is NO, the process proceeds to S276. When the determination result in S273 is YES, in S274, the remote monitoring unit 366 determines the priority of remote driving for respective remote driving vehicles 10 based on the abnormal state occurred in each remote driving vehicle 10 in S274. do.

The remote monitoring unit 366 sets the remote driving vehicle 10 that has encountered a situation related to a traffic accident as the remote driving vehicle 10 that has the highest priority for remote driving. As the remote driving vehicle that has the second highest priority for remote driving, the remote monitoring unit 366 may set the remote driving vehicle 10, which is encountering a situation where the remote driving vehicle would block the road or obstruct a passage of other vehicles if the remote driving vehicle makes a stop. As the remote driving vehicle that has the third highest priority for remote driving, the remote monitoring unit 366 may set the remote driving vehicle 10 which blocks the road due to a stop. When two or more remote driving vehicles 10 have the same priority, the priority of the remote driving vehicle 10 that encountered the abnormality first may be set to the higher priority.

In S275, the presentation control unit 367 notifies the remote driver 21 of the remote driving vehicle 10, which has a high priority for remote driving, together with the details of abnormality occurred in the remote driving vehicle 10. The remote driver 21 refers to the notification of the priority and determines the remote driving vehicle 10 to be remotely driven, that is, the remote driving vehicle 10 to which the remote assist operation unit 368 provides the driving instruction value to be used in the remote driving.

In S276, the remote monitoring unit 366 determines whether the abnormality is resolved. If one or more remote driving vehicles 10 are still in abnormal states (276: NO), the process returns to S271 and notification of the abnormality and priority is continued. When all the abnormalities have been resolved (276: YES), the abnormality notification is terminated in S277. In S277, resolution of the abnormality may be notified.

### (Abnormality Handling Process in Convoy Traveling)

The remote control device 36 starts the process shown in FIG. 15 (hereinafter referred to as convoy management process) when an abnormality occurs in one of the multiple remote driving vehicles 10 traveling in convoy. Convoy traveling is a state in which multiple (two or more) remote driving vehicles 10 are traveling by following the preceding vehicle with an inter-vehicle distance being maintained automatically.

In S291 of the convoy management process, the remote monitoring unit 366 acquires details of the abnormality occurred in the remote driving vehicle 10 (hereinafter referred to as abnormal vehicle) and a position of the abnormal vehicle in the convoy. In S292, the remote monitoring unit 366 determines whether the vehicle in which the abnormality has occurred can continue the traveling. When the determination result in S292 is NO, the convoy management process is ended. In this case, the remote driving facility 20 temporarily stops all of the remote driving vehicles 10 traveling in convoy and moves the occupant 14 who is on board the abnormal vehicle to another normal remote driving vehicle 10. This is carried out under the initiative of the remote driving facility 20, that is, the remote driver 21 or the remote administrator 25.

When the determination result in S292 is YES, the remote monitoring unit 366 determines, in S293, whether the vehicle in which the abnormality has occurred is a front remote driving vehicle. The front remote driving vehicle is the remote driving vehicle 10 that travels ahead of other remote driving vehicles 10. When the determination result in S293 is YES, in S294, the remote assist operation unit 368 provides a convoy change instruction to each remote driving vehicle 10 in the convoy. The convoy change instruction is an instruction for switching the position of front remote driving vehicle, which corresponds to the abnormal vehicle, with the position of rear remote driving vehicle, which is the normal remote driving vehicle 10. According to the convoy change instruction, the normal remote driving vehicle 10 passes the stopped abnormal vehicle and moves in front of the abnormal vehicle. As described above, the convoy traveling can be continued such that the abnormal vehicle follows the normal remote driving vehicle 10.

When the determination result in S293 is NO, the remote assist operation unit 368 provides each remote driving vehicle 10 with an instruction to maintain the convoy traveling in S295. Thus, the convoy traveling can be continued such that the abnormal vehicle follows the normal remote driving vehicle 10.

Note that when three or more remote driving vehicles 10 are traveling in convoy, the remote monitoring unit 366 determines whether the vehicle in which the abnormality has occurred is the leading vehicle or the last vehicle in the convoy. When the vehicle in which the abnormality has occurred is the leading vehicle or the last vehicle, the remote assist operation unit 368 provides each remote driving vehicle 10 with an instruction for moving the vehicle in which the abnormality has occurred to a middle position of the convoy. As described above, the convoy traveling can be continued with the abnormal vehicle being protected by the normal front remote driving vehicle 10 and the normal last remote driving vehicle 10.

### Summary of Second Embodiment

The second embodiment described above also provides the same effects as the first embodiment. In the second embodiment, when the mode switching unit 1427 permits the in-vehicle driving, the travel control ECU 150 that controls the traveling of remote driving vehicle 10 sets the travel speed of remote driving vehicle 10 for in-vehicle driving to be lower than the travel speed of the remote driving vehicle 10 when traveling in remote driving mode (S210). Thus, even after the in-vehicle driver 12, who is less accustomed to driving operation of the remote driving vehicle compared with the remote driver 21, takes over control of the driving operation, the remote driving vehicle 10 can continue stable traveling.

When the mode switching unit 1427 permits the in-vehicle driving, the mode switching unit 1427 further determines whether to permit the specific occupant 14s to perform the in-vehicle driving based on the occupant information of the specific occupant 14s who attempts to operate the in-vehicle driving operation member 13 (S208). Thus, a situation in which control of driving operation is taken over by an undesirable occupant 14 can be avoided.

The mode switching unit 1427 acquires, from the remote system 30, the determination result, which is based on the occupant information and indicates whether the in-vehicle driving is permitted for the specific occupant 14s. Then, the mode switching unit 1427 determines whether to permit the specific occupant 14s to perform the in-vehicle driving according to the acquired determination result (S208). This configuration enables a proper determination for determining whether the specific occupant 14s is suitable for performing the in-vehicle driving of the remote driving vehicle 10. As a result, even after switching to the in-vehicle driving, the remote driving vehicle 10 can continue stable traveling.

When the mode switching unit 1427 acquires replacement information indicating a replacement of the remote driver 21 who performs remote driving from the remote system 30, the mode switching unit 1427 uses the in-vehicle notification unit 130 provided in the remote driving vehicle 10 to notify switch of the remote driver 21 based on the replacement information (S252). According to this configuration, even when a change in vehicle behavior occurs due to a change of the remote driver 21, the occupant 14 in the remote driving vehicle 10 is less likely to feel anxious.

The mode switching unit 1427 determines whether there is a substitute for the remote driver 21 who performs the remote driving. When there is no substitute for the remote driving, partial driving function of the remote driving vehicle 10 is restricted (S254). According to this configuration, even when the operation of multiple remote driving vehicles 10 is managed by the remote system 30, appropriate risk management is possible.

The remote assist operation unit 368 provides the driving instruction value for remote driving to a specific remote driving vehicle 10, among the multiple remote driving vehicles 10 under the management of the remote system 30. When remote driving requests are acquired from multiple remote driving vehicles 10, the presentation control unit 367 notifies the remote driver 21 of remote driving vehicle with higher priority (S275). According to this configuration, even when the operation of multiple remote driving vehicles 10 is managed by the remote system 30, the remote driver 21 can properly select the remote driving vehicle 10 for which the remote driving should be performed by taking over the driving operation.

When an abnormality occurs in the front remote driving vehicle among the multiple remote driving vehicles 10 that travel in convoy, the remote assist operation unit 368 controls provides instructions to the front remote driving vehicle, which is in abnormal state, and the rear remote driving vehicle, which is in normal state, such that the position of front remote driving vehicle is switched to the position of rear remote driving vehicle (S294). According to this configuration, when a minor abnormality occurs in the front remote driving vehicle, the convoy traveling can be continued. As a result, convenience for the occupant 14 can be ensured while appropriately managing the risk.

The mode switching unit 1427 displays, on the external display unit 135, driving state information indicating whether the remote driving vehicle 10 is performing remote driving or in-vehicle driving, toward outside of the vehicle. According to this configuration, pedestrians or periphery person around the remote driving vehicle 10 are less likely to feel anxiety about the remote driving vehicle 10.

In the second embodiment, the occupant information acquisition device 220 corresponds to an in-vehicle driver monitoring device, the travel control ECU 150 corresponds to a travel control unit, the presentation control unit 367 corresponds to a notification control unit, and the remote assist operation unit 368 corresponds to an instruction providing unit. The state determination unit 1426 corresponds to a remote abnormality determination unit, and the mode switching unit 1427 corresponds to an in-vehicle driving permission unit.

Although embodiments of the present disclosure have been described above, the present disclosure is not limited to the above-described embodiments, and the following modifications are also included in the present disclosure. Further, various modifications can be made without departing from the spirit of the present disclosure.

### First Modification

When permitting the in-vehicle driving, the in-vehicle driving permission unit 1422 may permit the occupant to only operate the brake as the in-vehicle driving operation.

### Second Modification

The remote driving vehicle 10 may output different notifications from the administrator notification device 34 in S6 depending on whether autonomous driving level 3 is being executed or autonomous driving level 2 or lower is being executed. Specifically, the notification can be made clear that the emergency degree is higher when the autonomous driving level 2 or lower is being executed than when the autonomous driving level 3 is being executed.

### Other Modifications

When the autonomous driving level 3 is being executed, the remote driving vehicle 10 may be temporarily stopped when switching from the remote driving to the in-vehicle driving.

In the remote driving state, the mechanical mechanism between the in-vehicle driving operation member 13 and the corresponding actuator may be disconnected, that is locked, thereby making it impossible for the in-vehicle driver to drive the vehicle using the in-vehicle driving operation member 13.

In the above embodiment, the remote abnormality determination unit 1421 determines whether the remote driver 21 or the remote system 30 has an abnormality. Alternatively, the remote abnormality determination unit 1421 may determine whether an abnormality is occurred only in the remote driver 21, or only in the remote system 30.

The remote driving vehicle 10 may be a vehicle that does not include the driver seat 11. The driver seat 11 is not necessary, such as when the in-vehicle driving operation member 13 is only a button for stopping the remote driving vehicle 10.

The ECU and control device described in the present disclosure are the control unit described below. In the present disclosure, the control unit and the method thereof may be implemented by a dedicated computer constituting a processor programmed to perform one or more functions embodied by a computer program. Alternatively, the control unit and the method thereof according to the present disclosure may be implemented by a dedicated hardware logic circuit. Alternatively, the control unit and the method thereof according to the present disclosure may be implemented by one or more dedicated computers configured to include a combination of a processor for executing computer program and at least one hardware logic circuit. The hardware logic circuit may be ASIC or FPGA.

The storage medium for storing the computer program is not limited to read only memory (ROM). The computer program described above may be stored in a computer-readable non-transitory tangible storage medium as instructions to be executed by a computer. For example, the computer program may be stored in a flash memory. Furthermore, the form of the storage medium may be changed as appropriate. The storage medium is not limited to the configuration provided on the circuit board, and may be provided in the form of a memory card or the like, inserted into a slot portion, and electrically connected to a control circuit such as an autonomous driving ECU or a remote control device. The storage medium may include an optical disk which forms a source of programs to be copied or to be distributed into the autonomous driving ECU or the remote control device, or a hard disk drive therefor.

What is claimed is:

1. A remote driving system controlling a remote driving vehicle, the remote driving vehicle being capable of performing a remote driving and an in-vehicle driving, the remote driving being performed by a remote driver, the in-vehicle driving being performed by operating an in-vehicle driving operation member installed in the remote driving vehicle, the remote driving system comprising:
a remote abnormality determination unit sequentially determining occurrence of an abnormality in a remote determination target, the remote determination target being the remote driver or a remote system operated by the remote driver; and
an in-vehicle driving permission unit permitting the in-vehicle driving in response to the remote abnormality determination unit determining occurrence of the abnormality in the remote determination target,
wherein the in-vehicle driving permission unit does not permit the in-vehicle driving when the remote abnormality determination unit fails to determine occurrence of the abnormality in the remote determination target.

2. The remote driving system according to claim 1, wherein
the remote abnormality determination unit sequentially determines occurrence of the abnormality in the remote driver and also sequentially determines occurrence of the abnormality in the remote system, and
the in-vehicle driving permission unit does not permit the in-vehicle driving when the remote abnormality determination unit determines that no abnormality is occurred in the remote driver and no abnormality is occurred in the remote system.

3. The remote driving system according to claim 2, further comprising
a travel control unit equipped to the remote driving vehicle, the travel control unit controlling traveling of the remote driving vehicle based on a driving instruction value acquired from the remote system,
wherein
the travel control unit is also capable of controlling traveling of the remote driving vehicle based on an operation amount of the in-vehicle driving operation member,
when the in-vehicle driving permission unit does not permit the in-vehicle driving, the travel control unit sequentially acquires a signal indicating the operation amount of the in-vehicle driving operation member, and
when the in-vehicle driving permission unit permits the in-vehicle driving, the travel control unit controls traveling of the remote driving vehicle based on the acquired signal indicating the operation amount of the in-vehicle driving operation member.

4. A remote driving system controlling a remote driving vehicle, the remote driving vehicle being capable of performing a remote driving and an in-vehicle driving, the remote driving being performed by a remote driver, the in-vehicle driving being performed by operating an in-vehicle driving operation member installed in the remote driving vehicle, the remote driving system comprising:
a remote abnormality determination unit sequentially determining occurrence of an abnormality in a remote determination target, the remote determination target being the remote driver or a remote system operated by the remote driver; and
an in-vehicle driving permission unit stopping the remote driving vehicle first and then permitting the in-vehicle driving in response to the remote abnormality determination unit determining occurrence of the abnormality in the remote determination target.

5. The remote driving system according to claim 4, wherein,
after the in-vehicle driving permission unit permits the in-vehicle driving, the remote driving vehicle automatically switches to an in-vehicle driving mode in response to detecting an operation made on the in-vehicle driving operation member.

6. The remote driving system according to claim 1, wherein
the remote driving vehicle is equipped with a driver seat and an in-vehicle driver monitoring device,
the driver is prepared for an in-vehicle driver to operate the in-vehicle driving operation member,
the in-vehicle driver monitoring device sequentially determines a consciousness level of the in-vehicle driver seated on the driver seat,
the remote abnormality determination unit sequentially determines occurrence of the abnormality in the remote driver and determines, based on a consciousness level of the remote driver, whether the remote driver has a sign of abnormality, and
when the remote abnormality determination unit determines that the remote driver has the sign of abnormality and the in-vehicle driver monitoring device determines the consciousness level of the in-vehicle driver, the in-vehicle driving permission unit permits the in-vehicle driving to one of the in-vehicle driver or the remote driver who has a higher consciousness level.

7. The remote driving system according to claim 1, wherein
the remote driving vehicle is capable of performing an autonomous driving without periphery monitoring obligation in which the driver has no obligation for periphery monitoring,
the autonomous driving without periphery monitoring obligation requires a driver to be prepared for takeover of driving operation,
the remote driving vehicle is equipped with a driver seat and an in-vehicle driver monitoring device,
the driver seat is prepared for an in-vehicle driver to operate the in-vehicle driving operation member,
the in-vehicle driver monitoring device monitors whether the in-vehicle driver seated on the driver seat is prepared for taking over the driving operation, and
when the remote abnormality determination unit determines occurrence of the abnormality in the remote determination target during execution of the autonomous driving without periphery monitoring obligation in remote manner, the in-vehicle driving permission unit permits the in-vehicle driving and continues the autonomous driving without periphery monitoring obligation by switching the driver of the autonomous driving without periphery monitoring obligation to the in-vehicle driver under a condition that the in-vehicle driver is prepared for taking over the driving operation.

8. The remote driving system according to claim 1, wherein
the in-vehicle driving permission unit permits only a brake operation as the in-vehicle driving.

9. The remote driving system according to claim 1, further comprising
a travel control unit controlling traveling of the remote driving vehicle,
wherein, in a case where the in-vehicle driving permission unit permits the in-vehicle driving, the travel control unit limits a travel speed of the remote driving vehicle to be lower compared with a case where the remote driving vehicle performs the remote driving.

10. The remote driving system according to claim 9, wherein,
in the case where the in-vehicle driving permission unit permits the in-vehicle driving, the in-vehicle driving permission unit further determines whether to permit a specific occupant, who attempts to operate the in-vehicle driving operation member, to perform the in-vehicle driving based on occupant information related to the specific occupant.

11. The remote driving system according to claim 10, wherein
the in-vehicle driving permission unit:
acquires, from the remote system, a determination result indicating whether to permit the specific occupant to perform the in-vehicle driving, the determination result being generated based on the occupant information; and
decides, according to the acquired determination result, whether to permit the specific occupant to perform the in-vehicle driving.

12. The remote driving system according to claim 1, wherein
the in-vehicle driving permission unit:
stops the remote driving vehicle when the remote abnormality determination unit determines occurrence of the abnormality in the remote determination target; and
after the remote driving vehicle is stopped, permits restart of the remote driving in response to execution of a resolution process for resolving the abnormality occurred in the remote determination target.

13. The remote driving system according to claim 1, wherein
the in-vehicle driving permission unit outputs a notification, via an in-vehicle notification unit equipped to the remote driving vehicle, in response to acquiring, from the remote system, replacement information indicating replacement of the remote driver who performs the remote driving.

14. The remote driving system according to claim 13, wherein
the in-vehicle driving permission unit determines whether a substitute for the remote driver exists, and restricts partial driving function of the remote driving vehicle when no substitute for the remote driver exists.

15. The remote driving system according to claim 1, wherein
the in-vehicle driving permission unit outputs, via an in-vehicle notification unit equipped to the remote driving vehicle, a notification about switch to the in-vehicle driving in response to the remote abnormality determination unit determining occurrence of the abnormality in the remote determination target.

16. The remote driving system according to claim 15, wherein
the remote driving vehicle is able to switch between an autonomous driving without periphery monitoring obligation and an autonomous driving with periphery monitoring obligation,
the remote driver has no obligation to monitor a periphery area during the autonomous driving without periphery monitoring obligation,
the remote driver has obligation to monitor the periphery area during the autonomous driving with periphery monitoring obligation, and
the in-vehicle driving permission unit sets contents of notifications to be different in a case where the remote abnormality determination unit determines occurrence of the abnormality in the remote determination target during the autonomous driving without periphery monitoring obligation from a case where the remote abnormality determination unit determines occurrence of the abnormality in the remote determination target during the autonomous driving with periphery monitoring obligation.

17. The remote driving system according to claim 1, further comprising
a remote driver monitoring device sequentially monitoring whether the remote driver is in a state suitable for the remote driving; and
an administrator notification device notifying, to an administrator, that the remote driver is not in the state suitable for the remote driving in response to a monitoring result acquired by the remote driver monitoring device indicating that the remote driver is not in the state suitable for the remote driving,
wherein the administrator is different from the remote driver and is capable of operating the remote system.

18. The remote driving system according to claim 17, wherein
the remote driving vehicle is able to switch between an autonomous driving without periphery monitoring obligation and an autonomous driving with periphery monitoring obligation,
the remote driver has no obligation to monitor a periphery area during the autonomous driving without periphery monitoring obligation,
the remote driver has obligation to monitor the periphery area during the autonomous driving with periphery monitoring obligation, and
the remote driver monitoring device sets contents of notifications to be different in a case where the remote abnormality determination unit determines occurrence of the abnormality in the remote driver during the autonomous driving without periphery monitoring obligation from a case where the remote abnormality determination unit determines occurrence of the abnormality in the remote driver during the autonomous driving with periphery monitoring obligation.

19. The remote driving system according to claim 1, further comprising an instruction providing unit providing a driving instruction value for performing the remote driving to a target remote driving vehicle when multiple remote driving vehicles including the remote driving vehicle are under management of the remote system; and
a notification control unit notifying the remote driver about the target remote driving vehicle having a higher priority than remaining remote driving vehicle when multiple requests for executing the remote driving are acquired from the multiple remote driving vehicles.

20. The remote driving system according to claim 1, further comprising
an instruction providing unit providing a driving instruction value for performing the remote driving to a target remote driving vehicle when multiple remote driving vehicles including the remote driving vehicle are under management of the remote system,
wherein
the multiple remote driving vehicles travel in convoy,
when the abnormality occurs in a front remote driving vehicle and no abnormality occurs in a rear remote driving vehicle, the instruction providing unit provides instructions to the front remote driving vehicle and the rear remote driving vehicle to switch a position of the front remote driving vehicle with a position of the rear remote driving vehicle, and
the front remote driving vehicle is the remote driving vehicle travels in front of remaining remote driving vehicle and the rear remote driving vehicle is the remote driving vehicle travels behind the front remote driving vehicle.

21. The remote driving system according to claim 1, wherein
the remote driving vehicle is equipped with an external display unit, and
the in-vehicle driving permission unit displays, on the external display unit toward outside of the remote driving vehicle, driving state information indicating whether the remote driving vehicle is performing the remote driving or the in-vehicle driving.

22. A remote driving method controlling a remote driving vehicle, the remote driving vehicle being capable of performing a remote driving and an in-vehicle driving, the remote driving being performed by a remote driver, the in-vehicle driving being performed by operating an in-vehicle driving operation member installed in the remote driving vehicle, the remote driving method comprising:
sequentially determining occurrence of an abnormality in a remote determination target, the remote determination target being the remote driver or a remote system operated by the remote driver;
permitting the in-vehicle driving in response to determining occurrence of the abnormality in the remote determination target; and
forbidding the in-vehicle driving in response to failing to determine occurrence of the abnormality in the remote determination target.

23. A remote driving method controlling a remote driving vehicle, the remote driving vehicle being capable of performing a remote driving and an in-vehicle driving, the remote driving being performed by a remote driver, the in-vehicle driving being performed by operating an in-vehicle driving operation member installed in the remote driving vehicle, the remote driving method comprising:
sequentially determining occurrence of an abnormality in a remote determination target, the remote determination target being the remote driver or a remote system operated by the remote driver; and
stopping the remote driving vehicle first and then permitting the in-vehicle driving in response to determining occurrence of the abnormality in the remote determination target.
